(19) United States
(12) Patent Application Publication
(10) Pub. No.: US 2025/0090946 A1
(43) Pub. Date: Mar. 20, 2025

(54) Mobile Game Controller with Floating Magnetic Connector

(71) Applicant: Backbone Labs, Inc., Vancouver, WA (US)

(72) Inventors: Joseph Koch, Ventura, CA (US); Maneet Khaira, Vancouver, WA (US); Ozhan Maker, San Diego, CA (US); Zachary Scott, Palo Alto, CA (US)

(73) Assignee: Backbone Labs, Inc., Vancouver, WA (US)

(21) Appl. No.: 18/369,000

(22) Filed: Sep. 15, 2023

(51) Int. Cl. A63F 13/24; A63F 13/23

(52) U.S. Cl. CPC A63F 13/24; A63F 13/23

(57) ABSTRACT

The following embodiment describe various example techniques for attaching a mobile computing device to a game controller. Some of those techniques use a magnetic connector in the game controller, and various example magnet/magnetic array configurations are described. In one embodiment, a float mechanism is provided to allow the magnetic connector in the game controller to move via a magnetic force to align with a corresponding magnetic connector in a mobile computing device. Various float mechanisms are described including those that float a magnetic connector island, float magnet(s) in the magnetic connector island, and float the entire island/bridge assembly. Additionally, various example bridge extension mechanisms are described, as well as example solutions for addressing pinch points. Example connect/play techniques are provided, as well as example power management and power handling techniques and example hardware configurations.

### BACKGROUND

A game controller can provide input to a video game (e.g., to control an object or character in the video game) and, optionally, to interact with other software. The video game may be running on a computing device that is locally connected with the game controller (e.g., a mobile phone or tablet) or a cloud-based computing platform, among other possibilities.

### BRIEF DESCRIPTION OF THE DRAWINGS

FIG. 1 is an illustration of an example game controller and mobile computing device of an embodiment.

FIG. 2 is an illustration of an example game controller and mobile computing device of an embodiment.

FIG. 3A is a perspective view of an example game controller of an embodiment with a magnetic connector.

FIG. 3B is a top view of the example game controller of FIG. 3A where a mobile computing device is in a landscape orientation.

FIG. 3C is a top view of the example game controller of FIG. 3A where a mobile computing device is in a portrait orientation.

FIG. 3D is a top view of the example game controller of FIG. 3A where a mobile computing device is moving from a landscape orientation to a portrait orientation.

FIG. 3E is a top view of an example game controller of an embodiment that uses alignment/orientation magnets to position a mobile computing device in one of a plurality of positions.

FIG. 4A is a diagram of an example game controller of an embodiment.

FIG. 4B is a cross-sectional view of the example game controller of FIG. 4A.

FIG. 4C is an illustration of an example configuration of a magnetic array of an embodiment.

FIG. 4D is an illustration of an example configuration of a magnetic array of an embodiment.

FIG. 4E is a cross-sectional side view of the example game controller of FIG. 4A.

FIG. 5A is an illustration of an example game controller of an embodiment having a magnetic array and an alignment/orientation magnet.

FIG. 5B is an illustration of an example game controller of an embodiment having a magnetic array without an alignment/orientation magnet.

FIGS. 6A-6E are illustrations of an example game controller of an embodiment.

FIGS. 7A-7E are illustrations of an example game controller of an embodiment.

FIGS. 8A-8D are illustrations of an example game controller of an embodiment with a pop-up magnetic connector.

FIGS. 9A-9B are illustrations of an example game controller of an embodiment.

FIGS. 10A-10B are illustrations of an example game controller of an embodiment.

FIGS. 11A-11D are illustrations of an example game controller of an embodiment.

FIGS. 12A-12C are illustrations of an example game controller of an embodiment in which left- and right-side handles move asymmetrically.

FIG. 13 is an illustration of an example game controller of an embodiment that provides float of a magnetic connector island in an X-direction.

FIG. 14 is an illustration of an example game controller of an embodiment that provides float of a magnetic connector island in both X- and Y-directions.

FIGS. 15A-15C are illustrations of an example game controller of an embodiment that provides float of a magnetic connector island in a Y-direction.

FIGS. 16A-16F are illustrations of an example game controller of an embodiment in which a magnet connector floats within a magnetic connector island.

FIGS. 17A-17H are illustrations of an example game controller of an embodiment that provides float of a magnetic connector island-bridge assembly in an X-direction using a rack-and-pinion system.

FIGS. 18A-18B are illustrations of an example game controller of an embodiment that provides float of a magnetic connector island-bridge assembly in an X-direction using a belt mechanism.

FIGS. 18C-18Y are illustrations of example game controllers of embodiments that provide float.

FIGS. 18Z1-18Z2 show a static island-independent handle of a game controller of an embodiment.

FIGS. 19A-19D are illustrations of near-field communication (NFC) chips used with an example game controller of an embodiment.

FIGS. 20-24 are block diagrams of example game controllers of an embodiment.

FIG. 25 is a power state diagram of a power management method of an embodiment.

FIG. 26 is a flow chart of a power handling method of an embodiment.

FIGS. 27-31 are flow charts of power handling methods for different battery priorities of an embodiment.

### DETAILED DESCRIPTION

### I. Introduction

As mentioned above, a game controller can provide input to a video game (e.g., to control an object or character in the video game) and, optionally, to interact with other software. The video game may be running on a computing device that is locally connected with the game controller (e.g., a mobile phone or tablet) or a cloud-based computing platform, among other possibilities.

Disclosed herein are various example techniques for attaching a mobile computing device to a game controller. Some of those techniques use a magnetic connector in the game controller, and various example magnet/magnetic array configurations are described. In one embodiment, a “float” mechanism is provided to allow the magnetic connector in the game controller to move via a magnetic force to align with a corresponding magnetic connector in a mobile computing device. Various float mechanisms are described including those that float a magnetic connector island, float the magnet(s) in the magnetic connector island, and float the entire island/bridge assembly. Additionally, various example bridge extension mechanisms are described, as well as example solutions for addressing pinch points. Example connect/play techniques are provided, as well as example power management and power handling techniques and example hardware configurations. Also, various use cases are described that relate to universality, portability, delay to play, and immersion. Any of these embodiments can be used alone or in combination with each other.

Before turning to a description of example implementations, the following section provides an overview of an example game controller and computing device. It should be understood that these are merely examples and other implementations can be used. Accordingly, none of the details presented herein should be read into the claims unless expressly recited therein.

### II. Overview of Example Game Controller and Computing Device

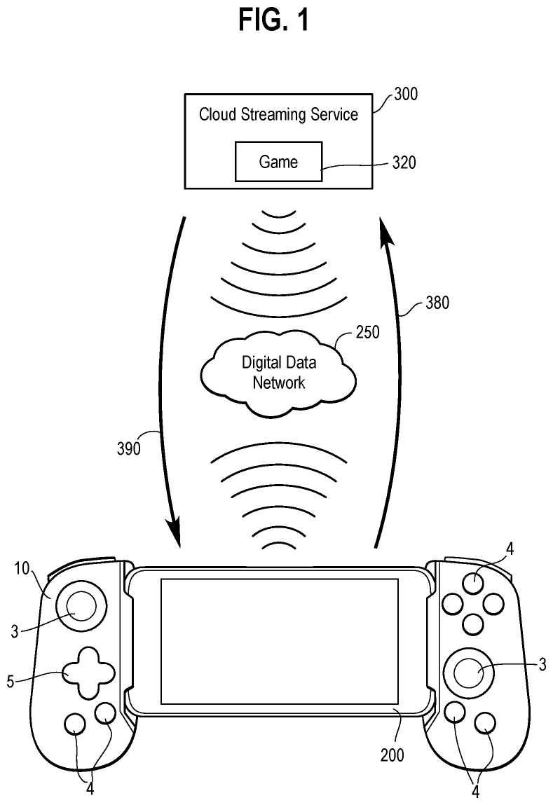

FIG. 1 is an illustration of an example game controller 10 and computing device (here, a mobile phone 200) of an embodiment. As shown in FIG. 1, the game controller 10 in this example has a number of user input elements (“control surfaces”), such as joysticks 3, buttons 4, and toggle switches 5. Other types of user input elements can be used, such as, but not limited to, a switch, a knob, a touch-sensitive screen/pad, a microphone for audio input (e.g., to capture a voice command or sound), a camera for video input (e.g., to capture a hand or facial gesture), etc. As will be discussed in more detail below, the game controller 10 can include a mechanism for communicating data and/or power with respect to the mobile phone 200 (e.g., by transmitting data and/or power to the mobile phone or receiving data and/or power from the mobile phone 200). As will also be discussed in more detail below, the game controller 10 can comprise one or more batteries (e.g., one battery in each of the two handles to balance the weight). Additionally, the game controller 10 can comprise one or more processors, and one or more non-transitory computer-readable media having program instructions stored therein that, when executed by the one or more processors, cause the game controller 10 to perform various functions, such as, but not limited to, some or all of the functions described herein. The game controller 10 can comprise additional or different components, some of which are discussed below.

In this example, the computing device takes the form of a mobile phone 200 (e.g., Android or iPhone). However, in other examples, the computing device takes the form of a tablet or other type of computing device. The mobile phone 200 in this example comprises a touch-screen display, a battery, one or more processors, and one or more non-transitory computer-readable media having program instructions (e.g., in the form of an app) stored therein that, when executed by the one or more processors, cause the mobile phone 200 to perform various functions, such as, but not limited to, some or all of the functions described herein. The mobile phone 200 can comprise additional or different components, some of which are discussed below.

In operation, the game controller 10 can be used to play a game that is locally stored on the mobile phone 200 (a “native game”) or a game 320 that is playable remotely via one or more digital data networks 250 such as a wide area network (WAN) and/or a local area network (LAN) (e.g., a game offered by a cloud streaming service 300 that is accessible via the Internet). For example, during remote gameplay, the computing device 200 can send data 380 to the cloud streaming service 300 based on input from the game controller 10 and receive streamed data 390 back for display on the phone's touch screen. In one example, a browser on the mobile phone 200 is used to send and receive the data 380, 390 to stream the game 320. The mobile phone 200 can run an application configured for use with the game controller 10 (“game controller app”) to facilitate the selection of a game, as well as other functions of the game controller 10. U.S. patent application Ser. No. 18/214,949, filed Jun. 27, 2023, which is hereby incorporated by reference, provides additional example use cases for the game controller 10 and the mobile phone 200.

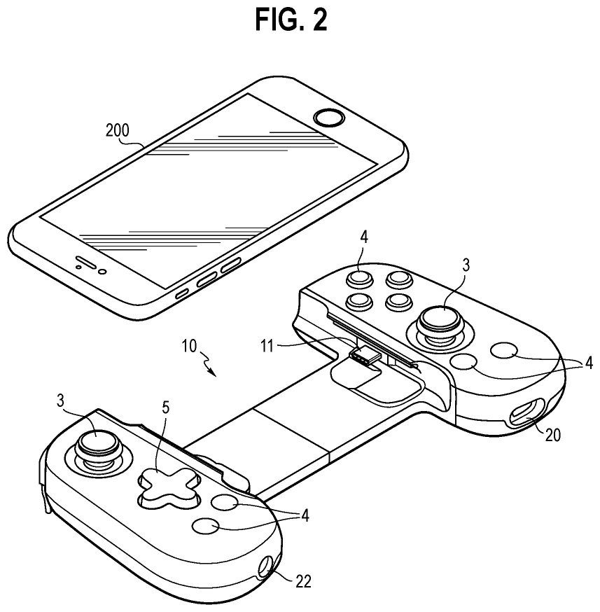

As shown in FIG. 2, in this example, the game controller 10 takes the form of a retractable device, which, when in an extended position, is able to accept the mobile phone 200 into the physical space between the game controller's handles. In operation, a user would pull the left and right handles of the game controller 10 apart while inserting the mobile device 200 into the game controller 10, aligning the male plug 11 with a corresponding female port on the mobile phone 200. To assist in this process, the game controller 10 can be configured such that once the handles are sufficiently pulled apart, the handles lock in place, allowing the user to easily insert the mobile device 200. Then, by applying light pressure on the handles, the user can unlock the handles and snap the game controller 10 shut, securing the mobile phone 200 to the game controller 10. More information about this and other mechanisms that can be used in the game controller 10 can be found in U.S. patent application Ser. No. 17/856,895, filed Jul. 1, 2022, which is hereby incorporated by reference.

As also shown in FIG. 2, the game controller 10 in this embodiment has a pass-through charging port 20 that allows the battery of the mobile phone 200 (and/or the battery/batteries of the game controller 10, if so equipped) to be charged, as well as a headphone jack 22. Further, in this example, a male communication plug 11 on the game controller 10 mates with a female communication port on the computing device 200 to place the controller 10 and computing device 200 in communication with one another. In this particular example implementation, the male communication plug 11 takes the form of a USB-C plug, although other types of plugs can be used. U.S. patent application Ser. No. 18/136,509, filed Apr. 19, 2023, and U.S. patent application Ser. No. 18/237,680, filed Aug. 24, 2023, both of which are hereby incorporated by reference, describe embodiments that can be used to help allow the game controller 10 to be used with mobile phones having different operating systems (e.g., Android vs. iOS).

### III. Example Attachment Techniques

The following sections describe various techniques that can be used to attach a game controller to a mobile computing device. It should be understood that these various techniques are merely examples and should not be read into the claims unless expressly recited therein.

### A. Example Game Controller with a Magnetic Connector

As mentioned above, in the example game controller 10 in FIG. 2, a user would pull the left and right handles of the game controller 10 apart while inserting the mobile device 200 into the game controller 10, aligning the male plug 11 with the corresponding female port on the mobile phone 200. The user can perform the reverse process to remove the mobile phone 200 from the game controller 10. Some users may find these processes difficult or cumbersome. For example, a user holding a mobile device in his right hand may need to use his left hand to pull the two handles apart when placing the mobile phone 200 between the two handles of the game controller 10. The user may also have trouble with inserting the male plug 11 on the game controller 10 into the female port in the mobile phone 200. The removal of the mobile phone 200 may also be difficult as the user attempts to pull the two handles apart with one hand. Locking the handles in place after the handles are pulled apart can assist in this process, but some users may still find the overall process cumbersome or inconvenient.

Users who encounter difficulties with the procedure for connecting the game controller 10 to the mobile phone 200 (or disconnecting the game controller 10 from the mobile phone 200) may use the game controller 10 less frequently or may even stop using the game controller 10 altogether (or decide not to purchase the game controller 10 in the first place). This can also manifest itself in the user not being able to find time to play, playing games on the mobile phone 200 but not with the game controller 10 attached, or playing games on other devices. Additionally, users who use a case on their mobile phones may not be able to fit their encased mobile phone into the game controller 10. This can provide another headwind to using the game controller 10 if the user finds it inconvenient to remove the case.

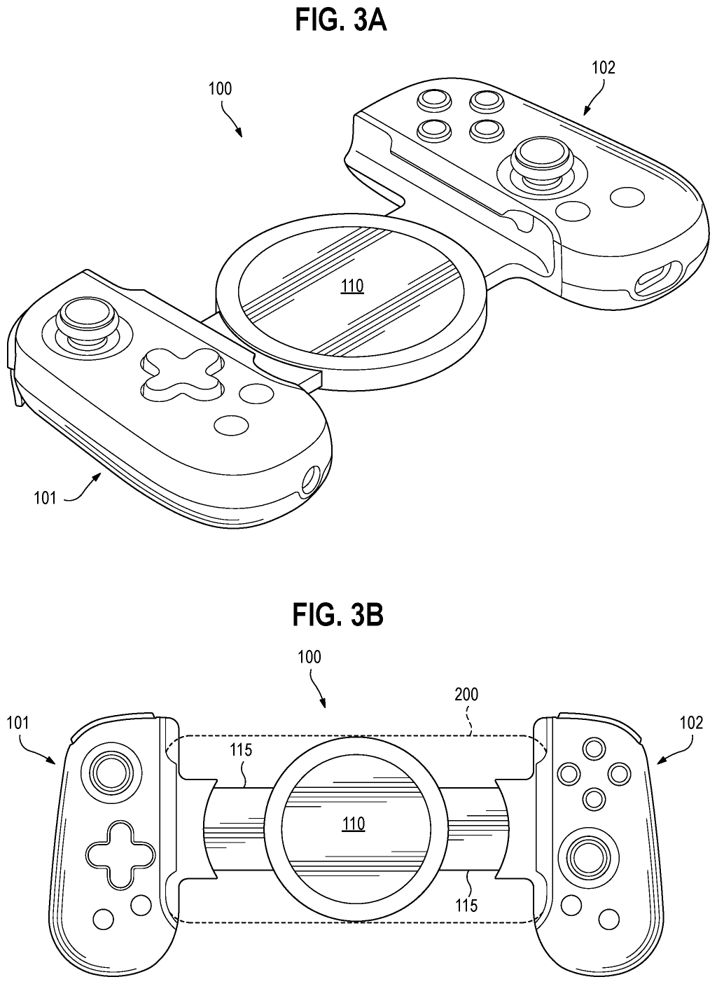

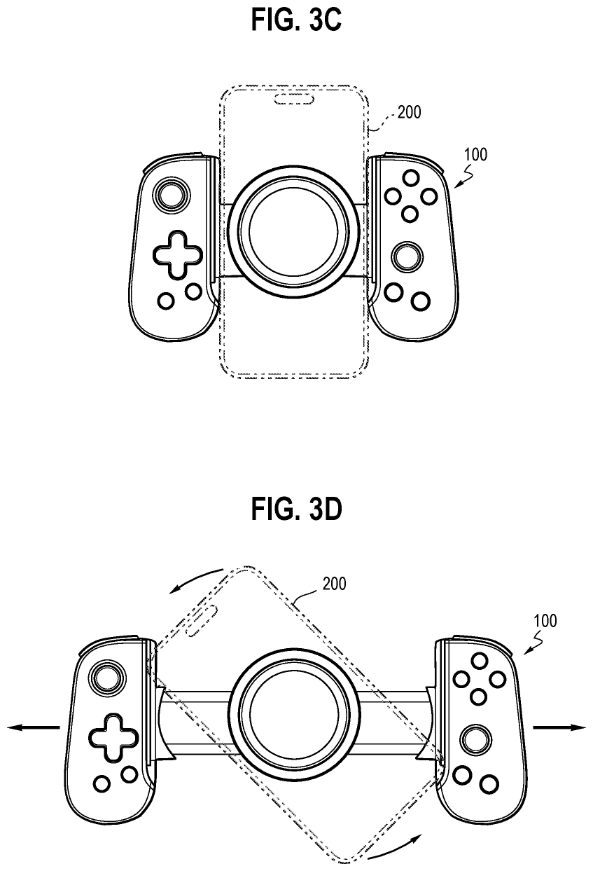

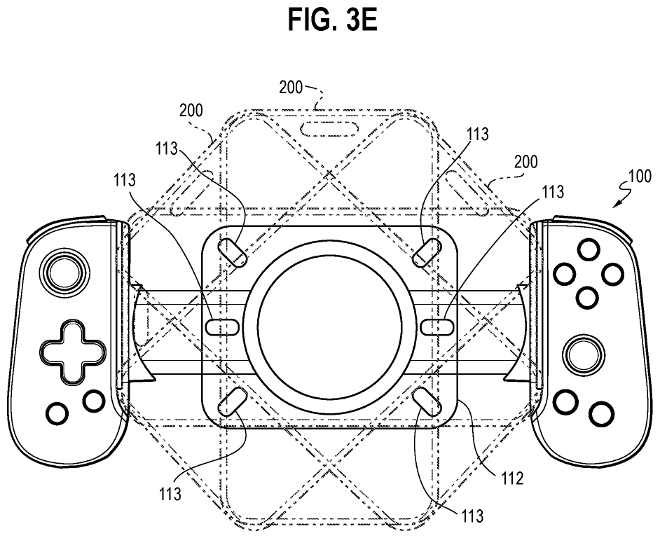

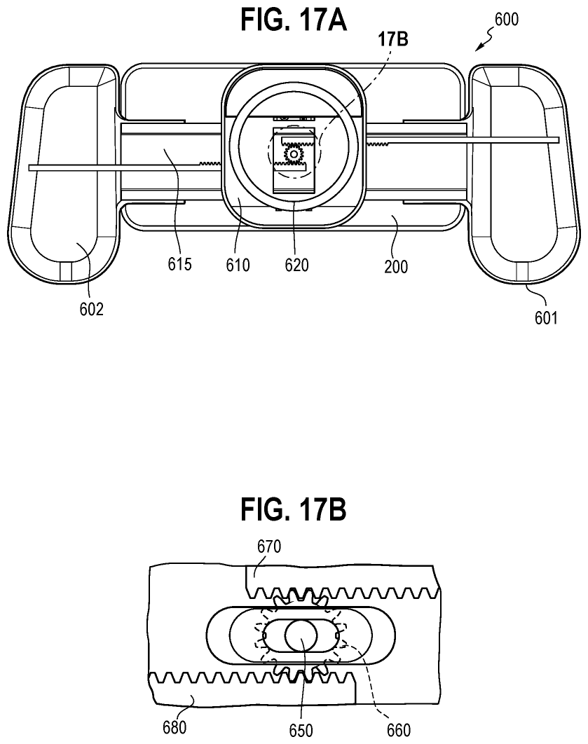

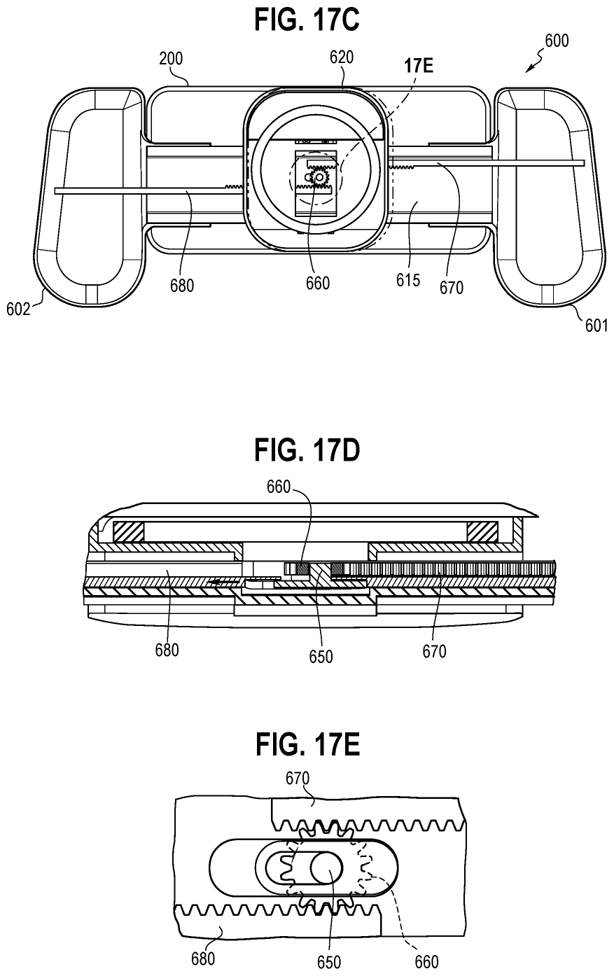

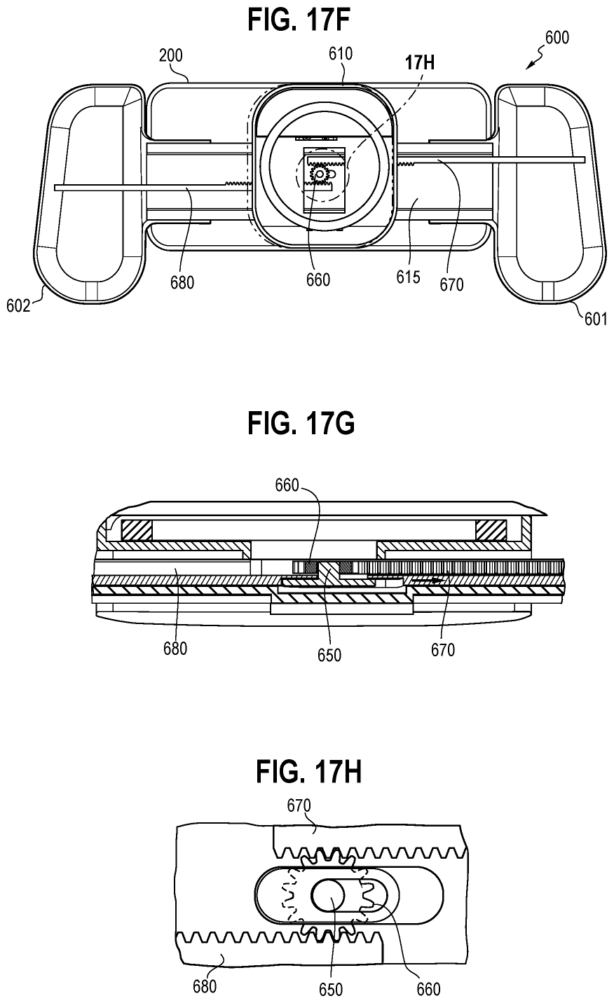

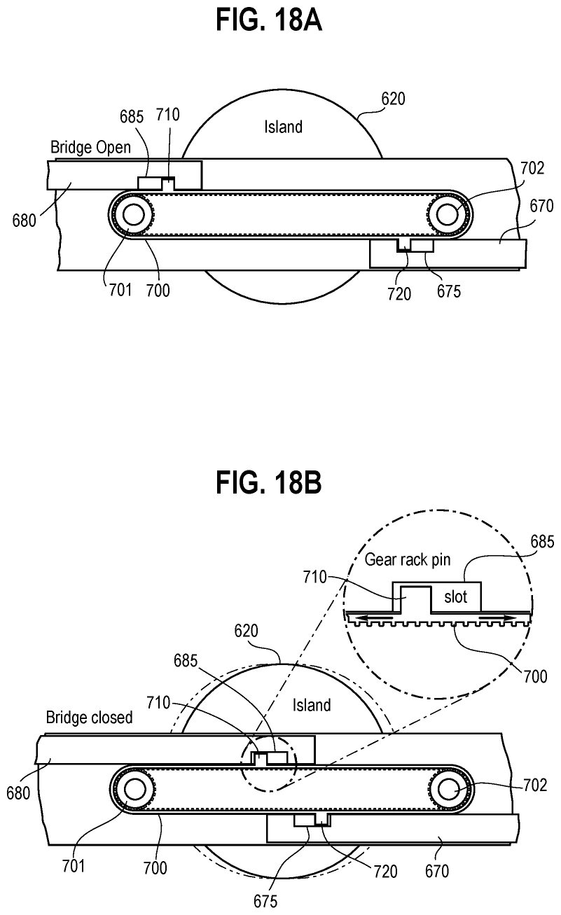

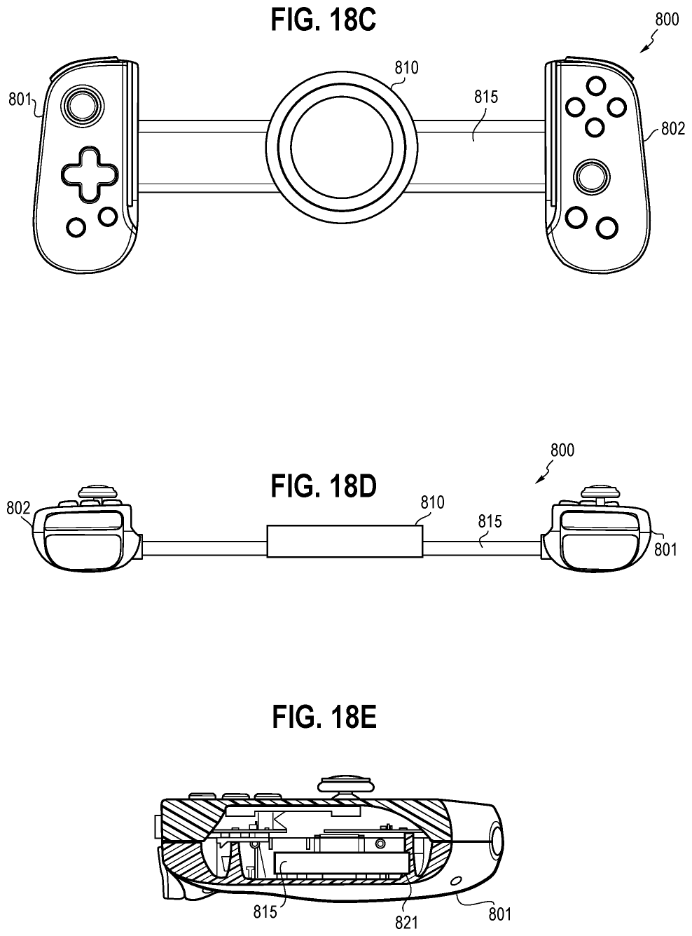

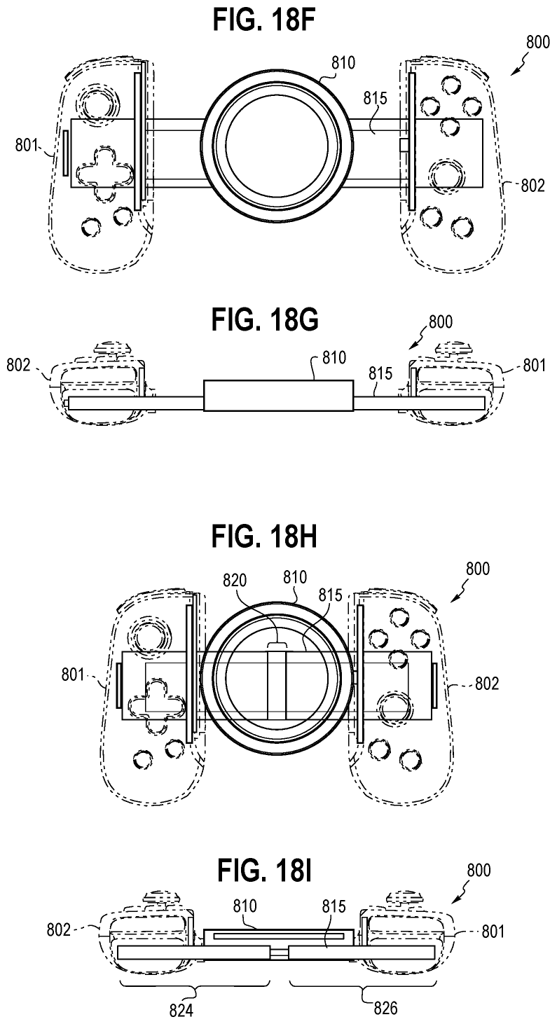

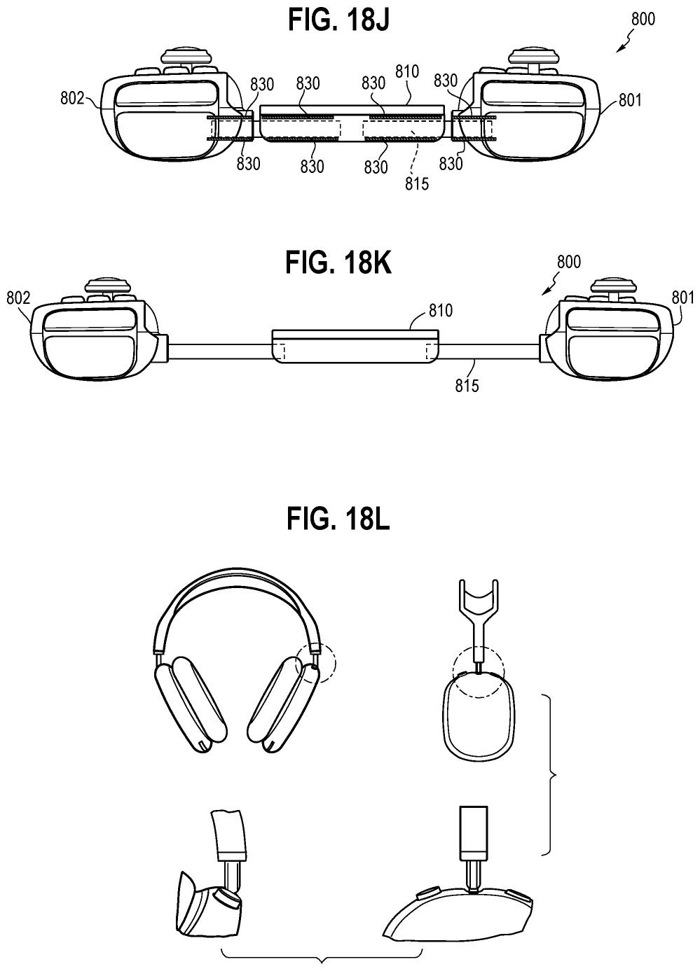

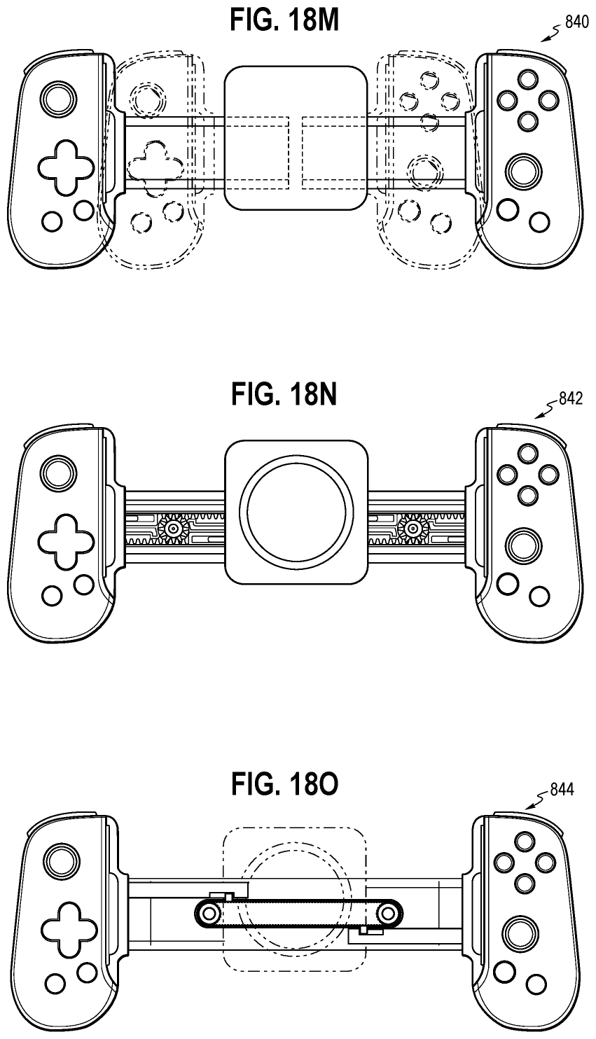

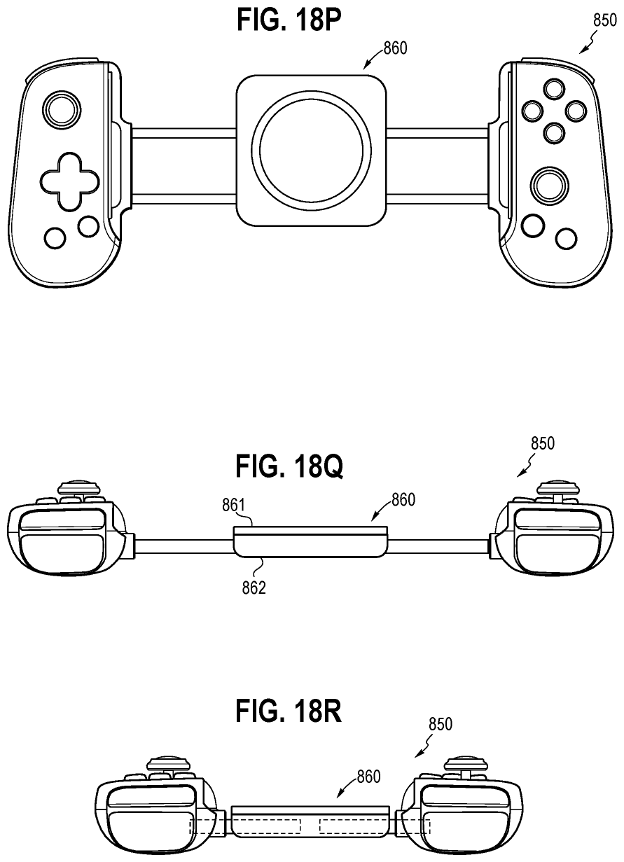

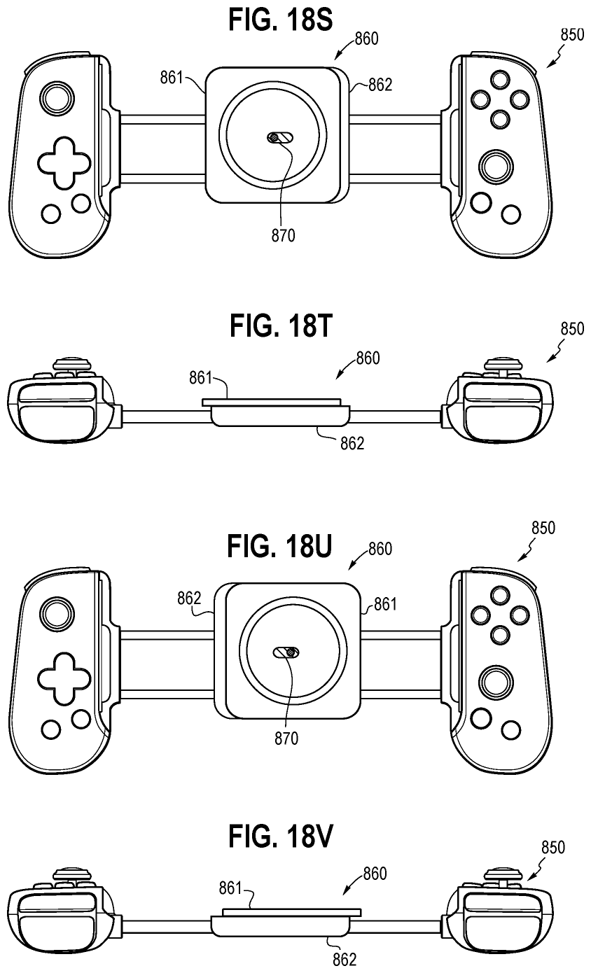

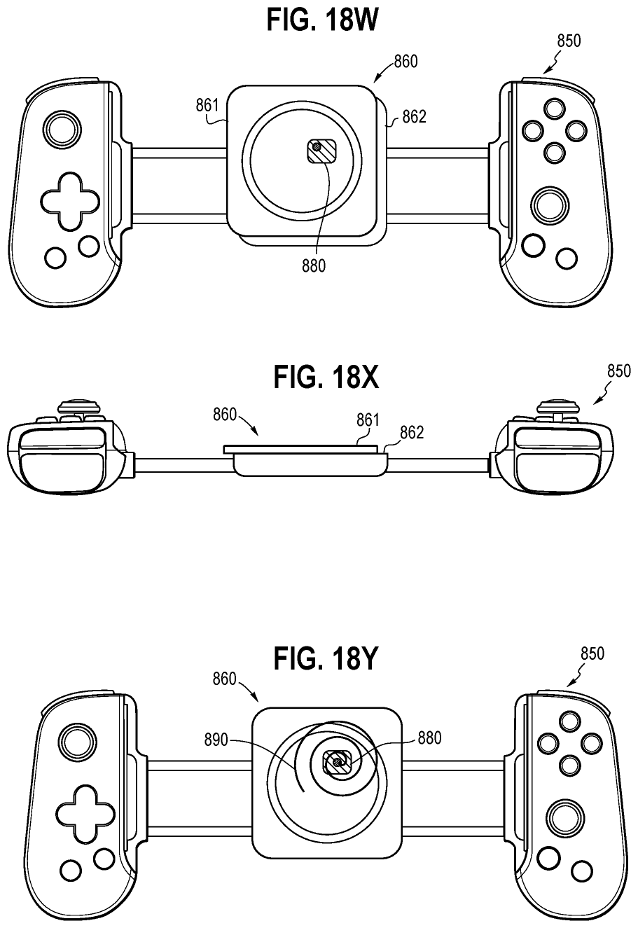

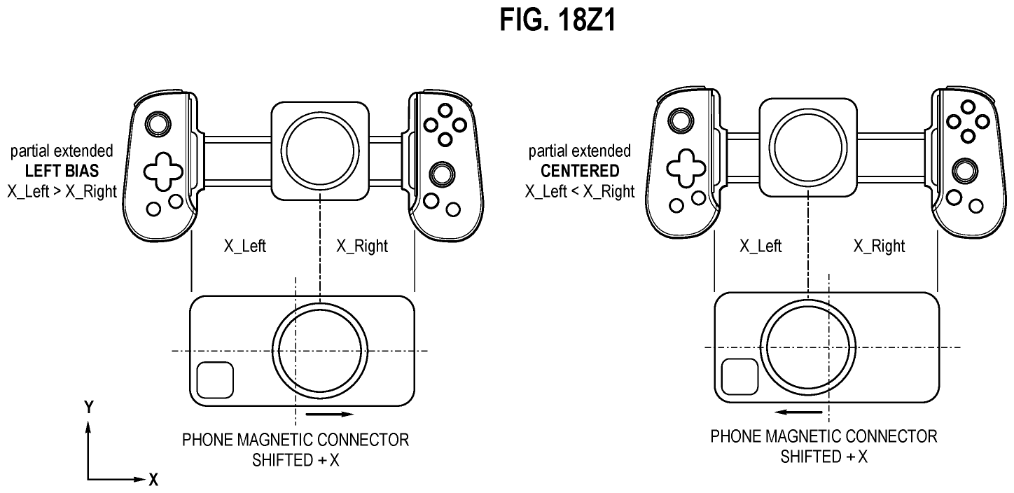

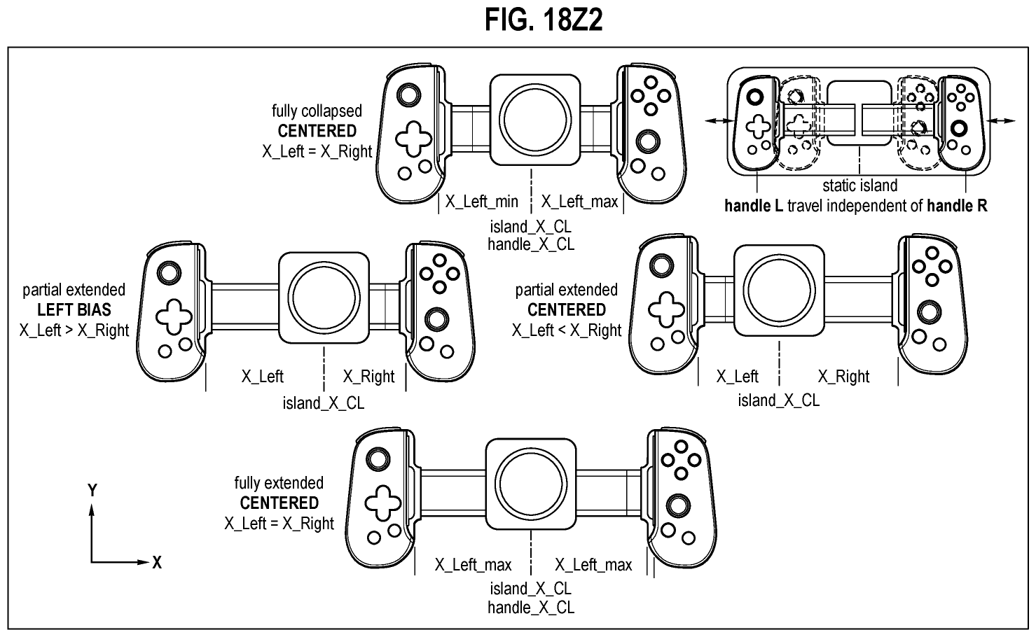

To address these and other problems, U.S. patent application Ser. No. 17/856,895, filed Jul. 1, 2022, which is hereby incorporated by reference, provides a game controller with a magnetic connector to magnetically retain the mobile phone to the game controller. FIGS. 3A and 3B correspond to FIGS. 17 and 18 in that application (with the figure and reference numbers changed). As shown in FIG. 3A and 3B, the game controller 100 of this embodiment has a magnetic connector island 110 on the bridge 115 spanning between the left and right handles 101, 102 of the game controller 100. The bridge 115 is in sliding engagement with each of the handles 101, 102 and has a span that extends between the handles 101, 102 that has a transverse midline. Each of the handles 101, 102 is configured to translate into a retraction direction toward the transverse midline of the span to a retracted configuration and also to translate to an extension direction away from the transverse midline of the span to an extended configuration. The magnetic connector island 110 is in the same plane as the handles 101, 102, and the magnetic connector island 110 is between the handles 101, 102 in the retracted configuration.

The magnetic connector island 110 comprises a magnetic connector that is configured to magnetically retain the mobile phone 200 to the game controller 100. The magnetic connector can take any suitable form, such as, but not limited to, a magnetic connector that uses Apple's MagSafe technology. In addition to magnetically retaining the mobile phone 200 to the game controller 100, the magnetic connector can provide magnetic induction for near-field communication (NFC) via near-field magnetic induction (NFMI). Additionally or alternatively, the magnetic connector can provide wireless charging of the mobile phone's battery from charge supplied by the game controller 100 and/or of the game controller's battery/batteries (if so equipped) from charge supplied by the mobile phone 200. As such, the game controller 100 of this embodiment does not need to have a male plug (e.g., a USB-C plug) for connection with the female port of the mobile phone 200. However, in other embodiments, the game controller 100 has both the magnetic connector and the male plug (e.g., for backup/redundancy, for other uses, etc.).

In the embodiment shown in FIGS. 3A and 3B, the left and right handles 101, 102 contain portions that hang over the mobile phone 200 to further retain the phone in the Z-direction (i.e., in the direction coming out of the page in FIG. 3B). To remove the mobile phone 200, the user can move the left and right handles 101, 102 outwardly to position the overhang portions away from the mobile phone 200. In another embodiment, the left and right handles do not include the overhang portions, and the magnetic force applied by the magnetic connector may be configured to provide an increased level of retention in the Z-direction to compensate for the lack of overhanging portions. In this embodiment, the mobile phone 200 may be removable from the game controller without moving the left and right handles (e.g., by simply lifting the mobile phone 200 off of the magnetic connector island 110). Accordingly, the phrase “magnetically retain the mobile phone” can mean solely/completely retain the mobile phone (e.g., when no other retention mechanism is used) or just partially retain the mobile phone 200 (e.g., when one or more other retention mechanisms may be used).

Also, in the embodiment shown in FIG. 3A and 3B, the left and right handles 101, 102 are substantially equidistant from the magnetic connector island 110 when the first and second handles 101, 102 are moved toward or away from the magnetic connector 110. In an alternate embodiment, the left and right handles 101, 102 are not substantially equidistant from the magnetic connector island 110. For example, a mechanical mechanism in the game controller 100 can cause one of the handles 101, 102 to travel a different distance than the other of the handles 101, 102 for the same amount of user push/pull. As yet another alternative, instead of being located on the bridge 115, the magnetic connector island 110 can be located in another location on the game controller 100 (e.g., in one or both of the handles 101, 102). Additionally, instead of being part of the game controller and/or the mobile computing device in a magnetic connector island, the magnetic connector can be part of an accessory or case attached to the game controller and/or mobile computing device. For example, if a mobile computing device does not possess an integrated magnetic attachment system, an add-on magnetic attachment adapter can be used. This adapter can comprise a magnetic array coupled with an adhesive or a mechanical device that facilitates bonding of the adapter to the mobile computing device, allowing the thus-configured mobile computing device to work with the game controller's integrated or attached magnet.

Further, the use of a magnetic connector in a game controller is a unique experience and can allow users to play content both in vertical and horizontal modes. For example, while FIG. 3B shows the mobile phone 200 is in a landscape/play orientation, as shown in FIG. 3C, the mobile phone 200 can be first placed in a portrait orientation by the user inserting the mobile phone 200 in the Z-direction (i.e., the axis going into the page in FIG. 3C), where the magnetic connector would capture and hold the mobile phone 200. The magnetic array in the magnetic connector island or the magnetic connector island itself can rotate upon open and close of the handles to allow easier insertion and allow the user to change orientation from portrait to landscape upon open/close to allow different gaming orientations automatically. For example, as shown in FIG. 3D, when the user pulls the handles of the game controller 100 apart, the magnetic connector island can rotate, with friction causing the mobile phone 200 to rotate as well into the landscape orientation. In another embodiment (see FIG. 3E), the game controller 100 has a magnetic connector island with a plurality of orientation magnets 113 that provide for a plurality of orientations of the mobile phone 200. (Orientation magnets may sometimes be referred to herein as alignment magnets as they can work to align a device in a certain orientation.)

There are many advantages to using a game controller with a magnetic connector to magnetically retain, communicate with, and/or exchange power with a mobile computing device. For example, such use can result in the removal of a wired connector on the game controller, which would remove the burden of adapters and constant design changes in order to accommodate different connector types, different phone sizes, and/or different case sizes. A magnetic “snap-in mechanism” can also reduce or remove the requirement of manual alignment and attachment to a physical connector. Additionally, the use of the magnetic connector can, in some situations, eliminate the need to accommodate for phone cases and/or can allow a user to avoid removing the phone case to use the game controller.

### B. Example Magnetic Array Configurations

As mentioned above, the magnetic connector can take any suitable form, such as, but not limited to, a magnetic connector that uses Apple's MagSafe technology. The magnetic connector can be, for example, an active-electromagnetic or an electro-permanent magnet. Electro-permanent magnets can be used to alter the magnetic field with low power draw, which may be desirable for a mobile product. Also, the magnet(s) in the magnetic connector can have any suitable configuration, and various magnetic arrangements can be used to create any desired shape or strength of magnetic field. The following paragraphs provide some example configurations. It should be understood that these configurations are merely examples and should not be read into the claims unless expressly recited therein.

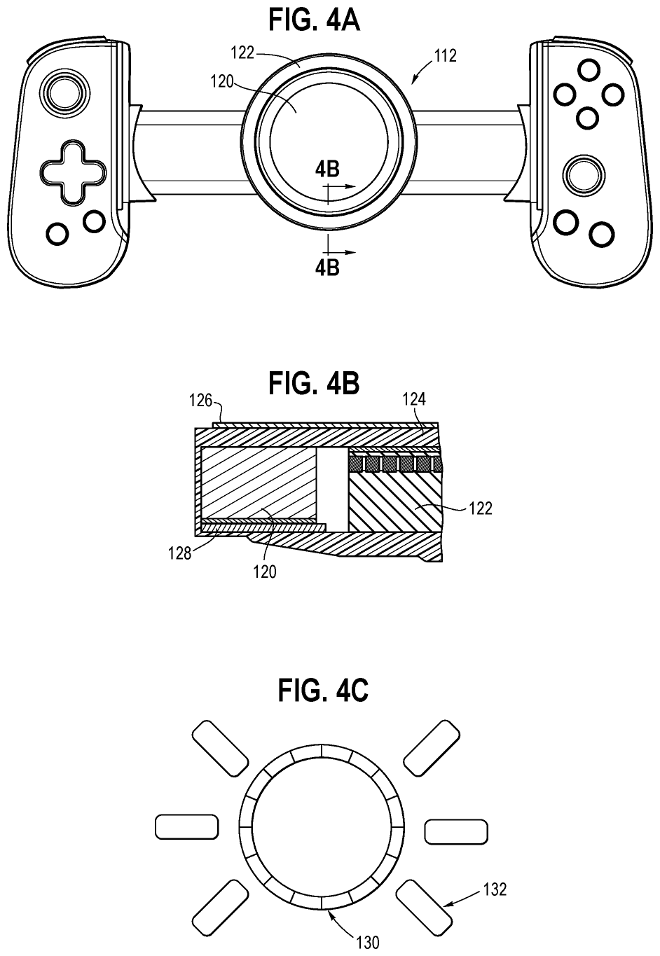

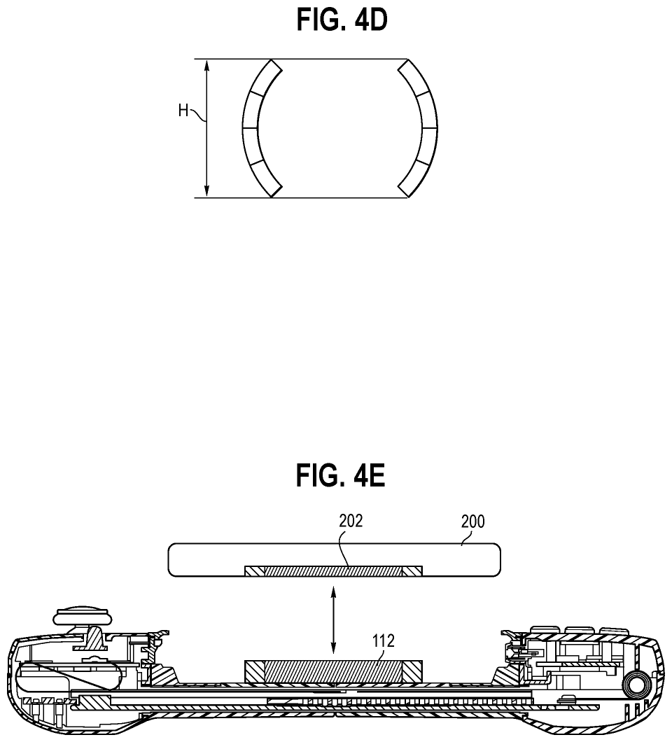

Turning again to the drawings, FIG. 4A shows a magnetic connector island 112 coupled with a bridge of a mobile game controller. The magnetic connector island 112 in FIG. 4A comprises a magnet (e.g., a toroid or filled magnet) or magnetic array 120 and a wireless communication and/or charging portion 122 (e.g., Qi charge board). (It should be understood that while Qi is used in some of the examples described herein, any suitable type of power transmitter (e.g., MagSafe) can be used.) In this example, wireless charging or communication antennas can be embedded around or inside the magnet array 120 (e.g., in the case of a hollow or toroidal magnetic array).

As shown in the cross-sectional view in FIG. 4B, in this example, the two portions 120, 122 are enclosed in an enclosure 124, with a controlled friction cap 126 (e.g., an elastomer or a controlled friction cap) at its top surface. The controlled friction cap 126 can be a covering layer of high-friction rubber or low-friction polyethylene terephthalate (PET). Altering the static and/or dynamic friction of the enclosure (rigid cap) 124 above the magnet/array 120 can change the shear force required to auto-align the mobile computing device and the shear force required to remove the mobile computing device. In one embodiment, the enclosure (rigid cap) 124 or covering layer 126 can be replaced by the user to alter the shear force behavior of the system. Also, magnetic shielding 128 is located below the magnet portion 120, which can reduce or eliminate harmful magnetic coexistence or interference.

In one embodiment, the height of the magnet 120 and the gap between the top of the magnet 120 and the top of the cap 126 relates to the pull force needed to pull the mobile computing device 200 away from the magnetic field of the magnet 120. For example, a pull force of 1,360 gf may be need when the height of the magnet 120 is 2.0 mm and the gap is 0.8 mm. In another example, a pull force of 745 or 680 gf may be need when the height of the magnet 120 is 1.2 mm and the gap is 1.0 mm.

The magnetic connector in the magnetic connector island 112 can take any suitable configuration. For example, in the configuration shown in FIG. 4C, the magnetic connector comprises an array of individual magnets 130 arranged in a circle. The array of smaller magnets connected together creates a similar magnetic field as a single large magnet but can be associated with less cost, more design flexibility, and reduced manufacturing complexity. In embodiments where the magnetic connector is comprised of multiple individual magnets or modules, the individual magnets or modules may also each have one or more degrees of translational and/or rotational freedom. This allows the magnetic field to be reconfigurable with a single magnetic array, enabling adjustable/arbitrary orientation of the mobile computing device (including for currently-unknown arbitrary arrays on unreleased products).

This example also has a plurality of optional alignment/orientation magnets 132, which are magnetized such that they only mate in a specific orientation. This provides an auto-location feature to ensure the mobile computing device is placed on the game controller in the correct orientation (e.g., “clocking” the rotation of the mobile computing device). More specifically, the magnetic fields can be arranged such that they only mate in one or more arbitrary additional discrete orientations and locations. Thus, when a mobile computing device is brought close to (but not necessarily in contact with) the game controller, the magnetic fields exert a moment and force on the mobile computing device, pulling it into the correct location and orientation. This can improve the user experience by not requiring the user to manually orient and locate the mobile computing device and/or game controller. The auto-location functionality can also be more precise than other location methods, allowing for efficient wireless charging and/or communication, which may require precise alignment of the mobile computing device and game controller. However, it should be noted that the use of alignment/orientation magnets is optional.

In another example (see FIG. 4D), the array of individual magnets are arranged in two arcs instead of a circle, which reduces the overall height H of the magnetic array. More generally, the shape of the magnetic array can be varied for aesthetic, performance, or ease-of-manufacturing reasons. The magnetic array can comprise, for example, a circle, square, rectangle or other polygon, filled or hollow. Also, the magnetic array can comprise a number of individual, unconnected magnets spread out over the product surface. In one embodiment, the magnets comprising the array are exposed to the user, providing increased magnetic force and a decorative benefit to the product.

FIG. 4E shows a cross-sectional view that illustrates how a mobile computing device (e.g., mobile phone 200) could attach to the game controller. As shown in FIG. 4E, a magnetic connector 202 of the mobile phone 200 is positioned over the magnetic connector 112 of the game controller. When the mobile phone 200 is placed on top of the game controller, the magnetic connectors 112, 202 magnetically retain the mobile phone 200 to the game controller. In addition, the magnetic connector 112 can provide magnetic induction for near-field communication and/or wireless charging.

It should be noted that a number of parameters can affect the behavior of the system. Such parameters include, but are not limited to, magnetic array strength, magnetic field shape, magnetization pattern, magnetization polarization, distance between the magnet array and the surface of the product, ferromagnetic parts proximal to the array, and the material and surface properties of the enclosure above the array, among others. Magnetic field strength can be important for a good user experience, and the magnetic array can take a significant amount of or all of the game controller's mass under dynamic load during use.

Also, the unique properties of the magnetic connector allow for constraint without regard to the mobile computing device's width, length, height, or shape. Magnetic attraction force only (or at least primarily) depends on the location and strength of magnets on the mobile computing device and game controller. The magnetic connector can easily be integrated into various shapes and sizes of mobile computing devices and game controllers and is typically smaller than the external width, length, and height of the mobile computing device or game controller. The ability to alter the magnet or magnetic array shape and size to fit different mobile computing devices or game controllers is another benefit.

Additionally, because of the unique attractive properties of magnets, a user can simply bring the magnets or magnetic connector in contact to enable the attachment force. (As noted above and as will be discussed in more detail below, additional, physical retaining mechanism(s) can be used.) By varying the strength or shape of the magnetic field (e.g., by selecting different strength or orientation magnets during assembly, or by actively using electromagnets), the attachment force and auto- orientation force/moment can be changed to alter the user experience. For example, a lower attachment force (and/or auto- orient force/moment) can be selected for lower-mass mobile computing devices, and a higher attachment force (and/or auto- orient force/moment) can be selected for users who aggressively handle the game controller to prevent dislocation of the mobile computing device.

In one embodiment, the magnetic attachment effect can be turned on/off or varied in strength by moving the magnet or magnetic connector closer or further from the attachment surface. The magnet or magnetic magnetic connector can possess one degree of translational freedom (the direction normal to the attachment surface) and can be moved using a user- or software-driven latch or other actuator. With this alternative, when the array is closer to the attachment surface, the attachment force is higher, and when it is further from the attachment surface, the attachment force is lower or virtually zero.

Additionally, the magnetic connector can facilitate an orientation and position detection method by the mobile computing device's integral magnetic compass. The mobile computing device can calculate its orientation and position with respect to the mobile computing device by measuring the mobile computing device's magnetic field. This is in contrast to orientation methods that use the mobile computing device's accelerometer to measure orientation relative to the Earth's gravitational field, which may not be ideal on a portable gaming device that is manipulated in various orientations during use. The mobile computing device can use this information to adjust the displayed graphics (e.g., switching to landscape mode) or to add visual effects to apps and games. Additionally, the mobile computing device can change display orientation for accessibility reasons (e.g., for a left-handed user).

The magnetic connector can also be used as part of an accessory ecosystem. For example, the magnetic connector an pair with a corresponding magnetic mating module that can be embedded or attached to any number of accessory products, including, but not limited to: cases, cooling devices, covers, adapters, decorative accessories, mounting devices, alternate input devices, powered modules, or other products that may benefit from the orientation and constraint features of the magnetic connector. Also, the magnetic mating module can comprise a similar magnetic connector magnet or magnetic to that embedded in the game controller but with inverse polarity to facilitate attachment. The mating module magnetic strength and magnet size can be optimized for each accessory scenario, providing increased or decreased attachment force and larger or smaller module volume for ease of manufacturing.

Additionally, the magnetic connector in the game controller can be dual-purposed as a haptic engine if they are allowed to move in one or more degrees of translational freedom. For example, when an in-game event on the mobile computing device occurs, an electromagnet can turn on, attracting the magnets in the game controller and/or mobile computing device and causing a thump or vibration. In yet another embodiment, if the gaming controller includes electromagnets, the electromagnets can serve a dual purpose as the magnetic core of a voice coil, exciting a membrane or other diaphragm and generating audio.

Also, as will be discussed in more detail below, the magnetic connector can be used for data transfer and authentication. For example, data can be encoded (permanently or otherwise) into the magnetic field of the game controller, which can be read by the mobile computing device and decoded for data transfer or authentication. In one embodiment, the game controller array comprises active electromagnets, allowing for active data transfer to the mobile computing device by varying the magnetic field.

These embodiments can also provide thermal benefits. For example, wireless charging, especially at high power, produces significant wasted heat. This heat can degrade the performance of the electronics (in particular, batteries and systems-on-chip (SOCs)). In many embodiments, the magnetic connector can ensure close surface contact between the mobile computing device and the game controller's magnetic module through the property of magnetic force to increase with the inverse of fourth power of distance (i.e., as the mobile computing device gets closer to the game controller, it gets pulled more strongly against it). Thermal transfer through conduction is highly sensitive to surface contact area. The magnetic connector can reliably ensure strong contact force over an arbitrarily large area, facilitating heat transfer out of the mobile computing device and into the game controller.

### C. Additional Example Game Controllers with a Magnetic Connector

The above sections described the use of a magnetic connector with reference to a particular design of the game controller. As noted above, that particular design was merely an example, and the following paragraphs provide examples of additional designs that can be used. It is important to note that these additional designs are also examples, and the claims should not be limited to any particular design of game controller unless explicitly recited therein.

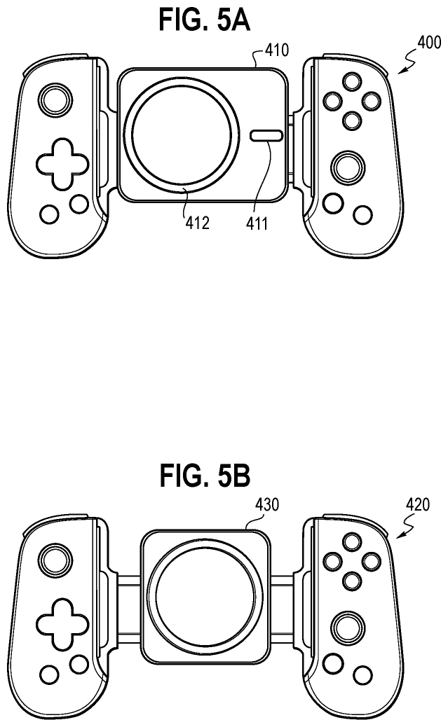

Turning again to the drawings, FIG. 5A is an illustration of a game controller 400 of another embodiment. The game controller 400 has a magnetic connector island 410 coupled with a bridge and located between two handles. The magnetic connector island 410 carries a magnetic connector (e.g., one or more magnets, such as a magnetic ring array) 412. The magnetic connector island 410 can include a housing, where the magnetic connector 412 can be enclosed entirely within the housing (so as to be hidden from view) or can be at least partially exposed outside of the housing (so as to be at least partially visible). In other embodiments, the magnetic connector island 410 does not include a housing and is simply a carrier without structure to cover one or more exposed sides of the magnetic connector 412.

In contrast to the circular shape of the magnetic connector island 110 in FIG. 3A and 3B, the magnetic connector island 410 of this game controller 410 is rectangular in shape, and the magnetic connector island 410 contains an alignment/orientation magnet 411 separate from the circular/ring magnetic array 412. The game controller 420 of FIG. 5B is similar, but its magnetic connector island 430 is square and does not have an alignment/orientation magnet. It should be noted that the rectangular and square shapes of the magnetic connector islands 410, 430 in FIGS. 5A and 5B do not necessarily mean that the magnets in those connectors 410, 430 are arranged in rectangular and square shapes. Indeed, as indicated by the ring in those rectangular and square shapes, the magnets are arranged in a circle in these examples.

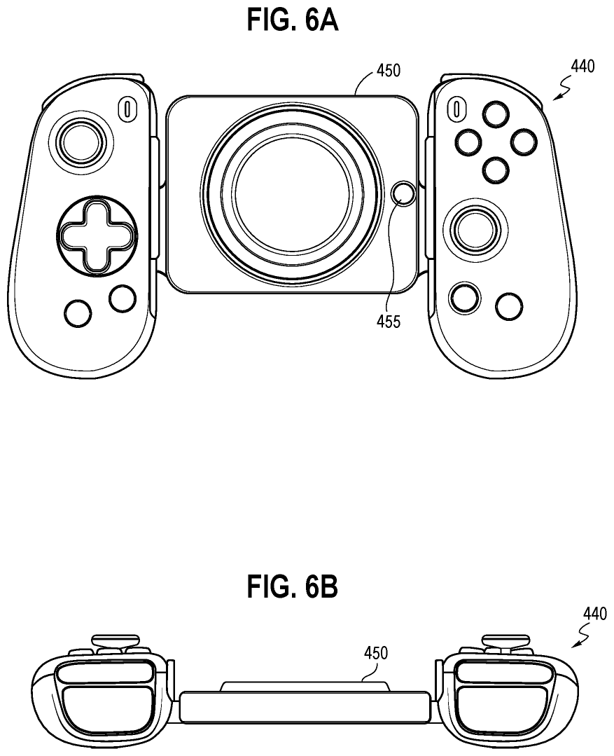

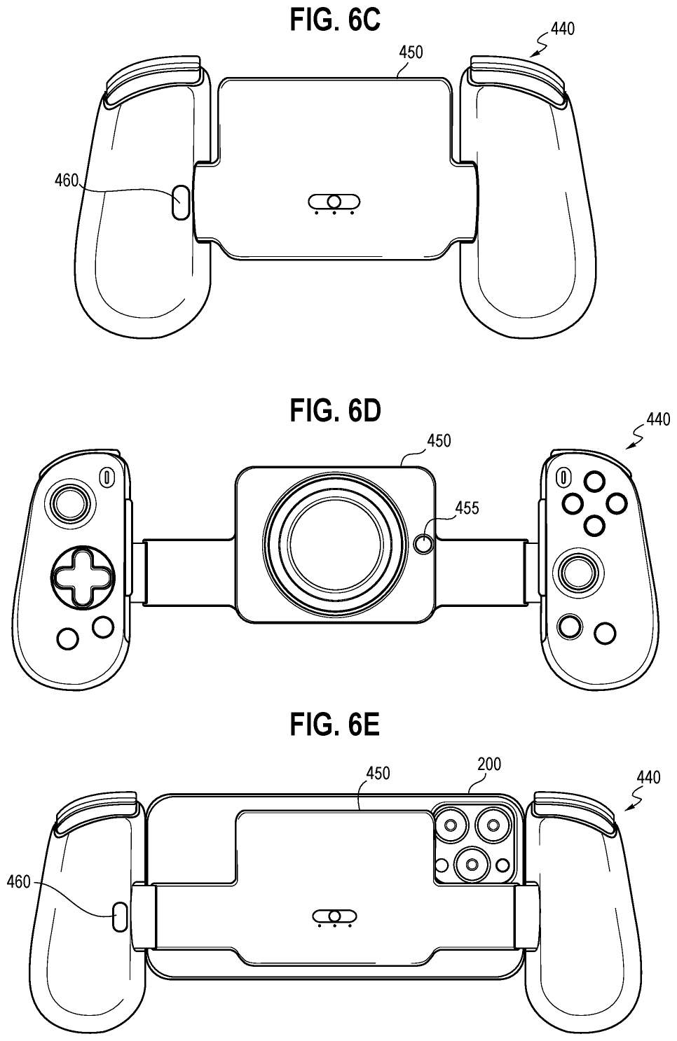

FIGS. 6A-6E illustrate another example game controller 440 with a magnetic connector island 450 coupled with a bridge of the game controller 440. In this example, a smaller, circular alignment/orientation magnet 455 is used to help achieve proper orientation of a mobile computing device. Also, as shown in FIGS. 6C and 6E, the back of the game controller 440 has a button 460, which, when pressed, causes the bridge to extend, moving one or both handles away from the magnetic connector island 450 to provide space for the mobile computing device 200. This button 460 is sometimes referred to as an “umbrella open” button, as a user may think of its function similar to a button on an umbrella that causes the umbrella to open. Also, while only one button 460 is shown in this example, in other examples, two buttons are used to allow for activation by either hand. Both buttons can have the same function (e.g., pressing either button will cause the bridge to extend in both directions, so only one button needs to be pressed) or different functions (e.g., pressing the left-side button extends the left-side bridge and pressing the right-side button extends the right-side bridge). Further, as shown in FIG. 6E, the magnetic connector island 450 in this example is sized to accommodate protruding camera features of the mobile phone 200 and provide clearance so as not to block the camera when the mobile phone 200 is inserted into the game controller 440.

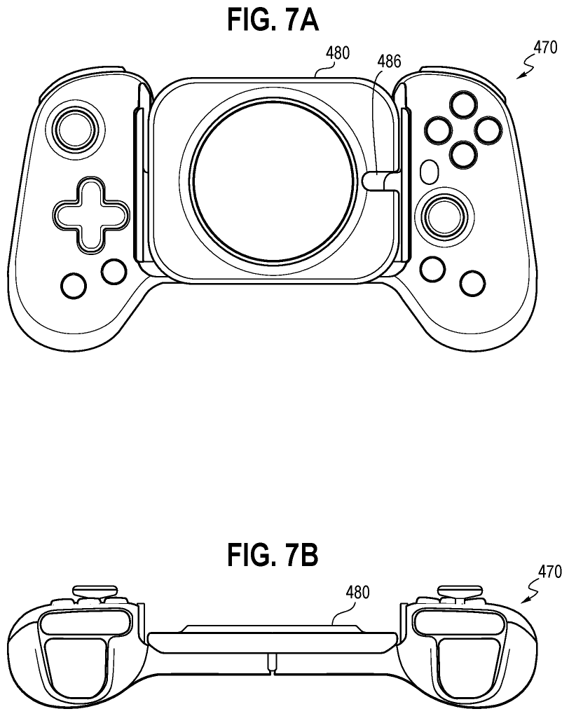

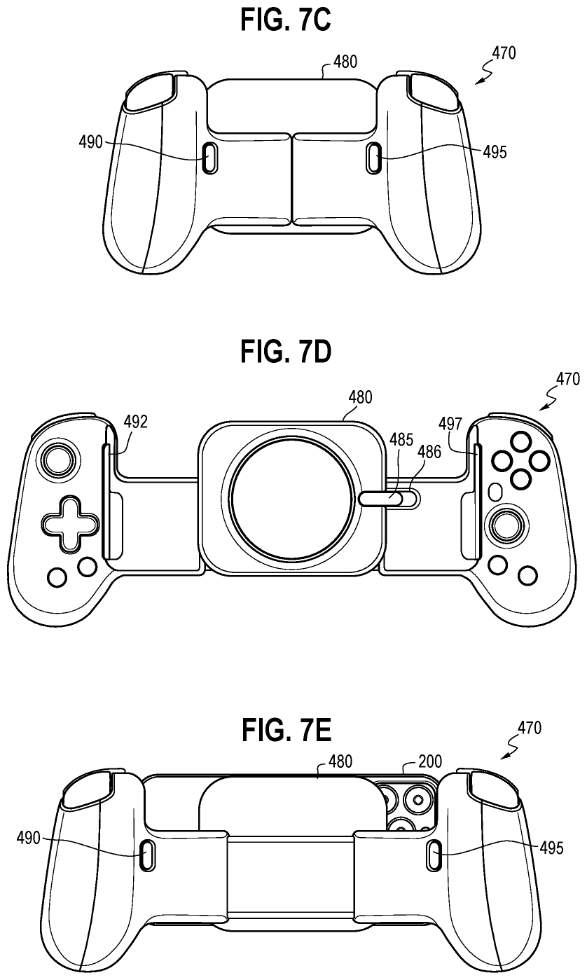

The example game controller 470 in FIGS. 7A-7E is similar to the example game controller 400 in FIG. 6A-6E, but there are some differences. For instance, instead of having a smaller, circular alignment/orientation magnet 455 (see FIG. 6A), the game controller 470 in this example has a larger alignment/orientation magnet 485 (see FIG. 7D) that is exposed under a notch 486 in the magnetic connector island 480 when the game controller 470 is expanded but slides under the magnetic connector island 480 to reduce the overall size of the game controller 470 when the game controller 470 is collapsed (see FIG. 7A). Also, the game controller 470 in this example has two “umbrella open” buttons 490, 495 (see FIGS. 7C and 7E), where the buttons 490, 495 can function as discussed above. Additionally, rubber pads 492, 497 on each handle add grip to help secure the mobile phone 200 in place.

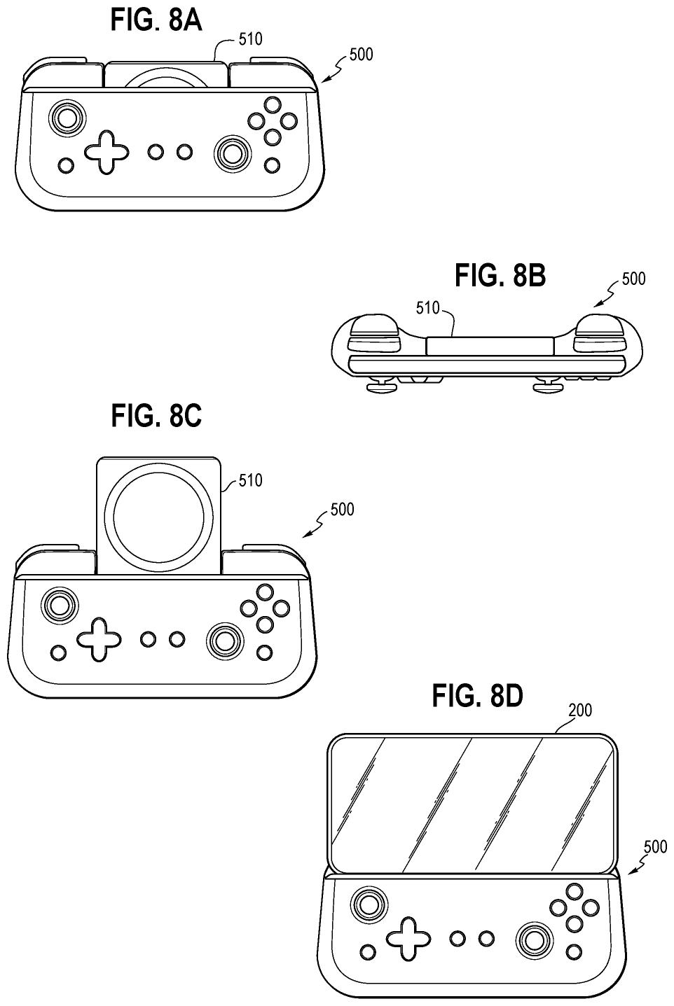

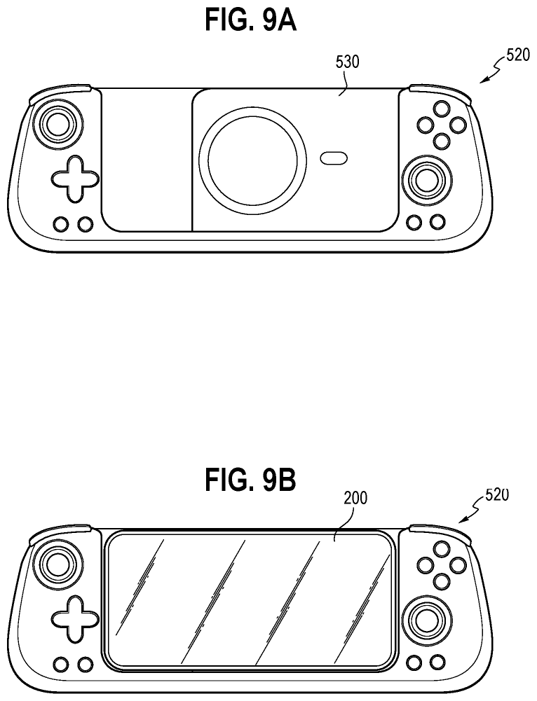

While the above example game controllers had a magnetic connector island on the extendable bridge, as noted above, a magnetic connector island can be located in a different location, especially if the game controller does not have a bridge. For example, the game controller 500 in FIGS. 8A-8D has a pop-up magnetic connector island 510 and does not use a bridge. As shown in FIGS. 8A and 8B, when not in use, the magnetic connector island 510 can be pushed down into the body of the game controller 500, resulting in a compact shape. When a user wants to use the game controller 500 to play a game, the user either pulls up the magnetic connector island 510 or interacts with a physical actuator on the game controller 500 (or a virtual actuator on the mobile phone 200) to extend the magnetic connector island 510 (see FIG. 8C), so it can accept the mobile phone 200 (see FIG. 8D). FIGS. 9A and 9B illustrate another example game controller 520 that does not have a bridge. In this game controller 520, the magnetic connector 530 island is part of the stationary housing between the left- and right-side handles. As shown in FIG. 9B, a user would simply place the mobile phone 200 in the indentation in the housing of the game controller 200.

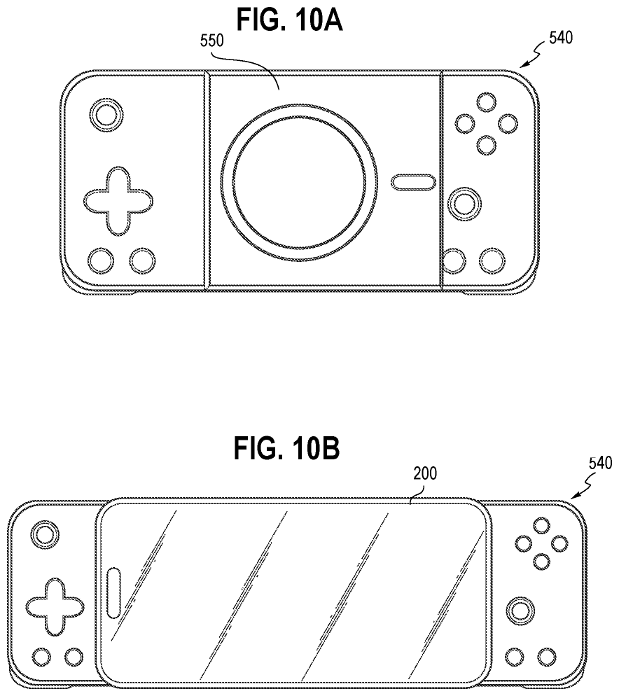

As yet another example, in the game controller 540 in FIGS. 10A and 10B, the magnetic connector island 550 has a height that is substantially the same as the height of the left- and right-side handles, which makes the game controller 540 look more “monolithic” than some of the other game controllers discussed above. Similar to some of the other game controllers discussed above, the left- and right-side handles move apart to allow the mobile phone 200 to sit on top of the game controller 540. The left- and right-side handles can independently open/close with bi-stable springs. Also, the game controller 540 can contain a clamp to help retain the mobile phone 200 in the “Y-direction” (i.e., in the direction substantially perpendicular to the axis running substantially between the left- and right-side handles). (As noted above, the X-direction is along the axis running substantially between the left- and right-side handles.)

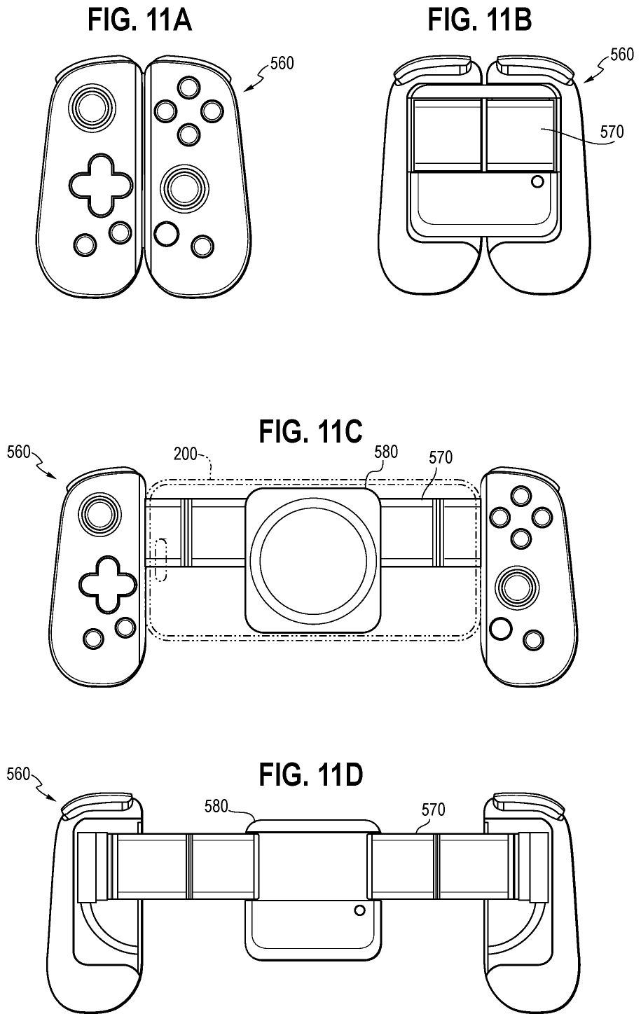

FIGS. 11A-11D show another example game controller 560 where the bridge 570 folds under the magnetic connector island 580, resulting in a very compact shape (see FIG. 11B). To use the game controller 560, a user would unfold the game controller 560 to extend the bridge 570 (see FIG. 11C), so the mobile phone 200 can be placed on the magnetic connector island 580.

Finally, it should again be noted that the various game controller designs discussed above are merely examples, and other designs can be used.

### D. Example Bridge Extension Mechanisms

An extendible bridge is used in many of the example game controllers discussed above. For example, referring back to FIGS. 3A and 3B, an extendible bridge 115 connects left- and right-side handles 101, 102 of the game controller 100, and a magnetic connector island 110 is positioned in the middle of the bridge 115. FIG. 3A shows the game controller 100 when the bridge 115 is not extended, and FIG. 3B shows the game controller 100 when the bridge 115 is extended. U.S. patent application Ser. No. 17/856,895, filed Jul. 1, 2022, which is hereby incorporated by reference, describes example mechanisms that can be used to extend and retract the bridge 115.

As shown in FIG. 3B, because the magnetic connector island 110 is symmetrical, the magnetic ring is centered between the left- and right-side handles 101, 102 of the game controller 100 both when the bridge 115 is retracted (FIG. 3A) and when the bridge 115 is extended (FIG. 3B). However, in some of the other example game controllers discussed above, such symmetry is not present. For example, in the game controller 400 in FIG. 5A, the magnetic connector island 410 contains both a magnetic ring array and an alignment/orientation magnet. As such, the magnetic ring array is not centered between the left- and right-side handles when the bridge is retracted, as shown in FIG. 5A. Using the same bridge extension mechanisms discussed above where the handles move in a synchronized, equidistance manner, the magnetic ring would also not be centered between the left- and right-side handles when the bridge is extended. This can cause misalignment of the magnetic ring for a mobile computing device that has its corresponding metal connector centered.

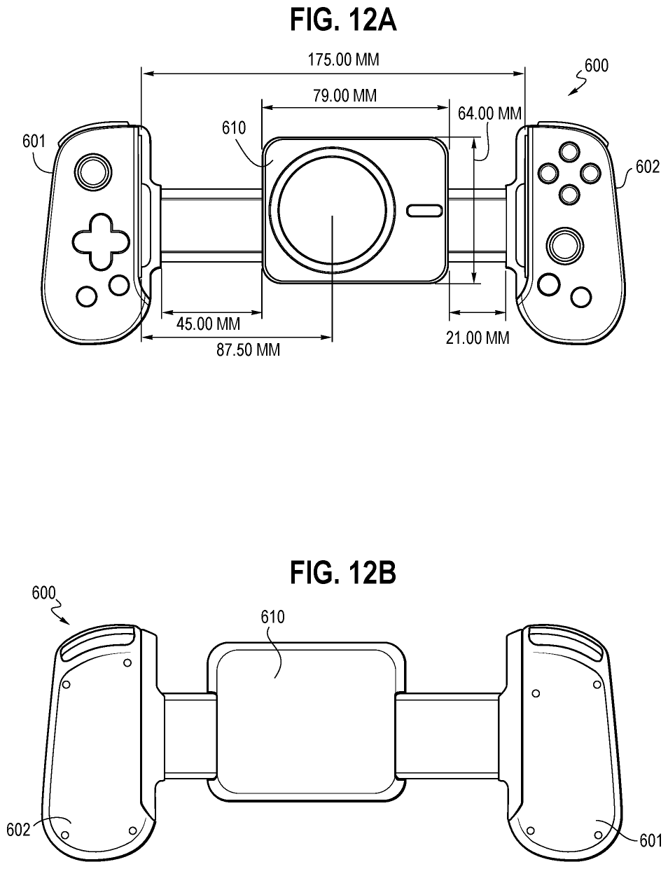

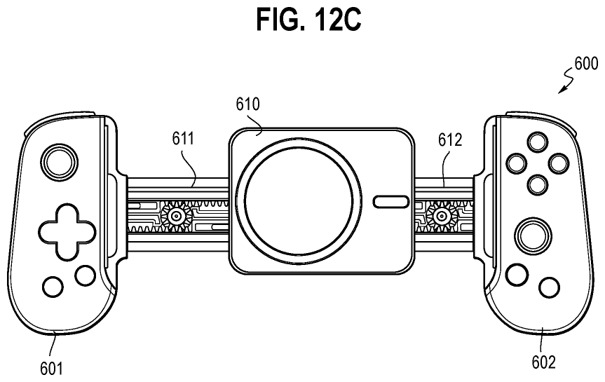

To address this problem, the extension mechanism in the game controller can move the left- and right-side handles in a non-synchronized, non-equidistant manner. For example, as shown in the game controller in FIGS. 12A and 12B, the left-side handle 601 moves farther away from the magnetic connector island 610 than the right-side handle 602 does when the bridge is extended. (FIG. 12A included example dimensions to illustrate this, but it should be understood that these dimensions are merely examples and should not be read as a limitation.) Because of this non-linear movement of the two handles 601, 602, when the bridge is fully extended, the magnetic ring of the magnetic connector island 610 is centered between the left- and right-side handles 601, 602. That is, while the bridge is asymmetric in appearance, it opens symmetrically from the center of the ring magnet, which is different from the center of the magnetic connector island.

Any suitable mechanism can be used to cause the bridge to open symmetrically from the center of the ring magnet instead of symmetrically from the center of the magnetic connector island. In one example implementation, a two-stage opening technique is used to accommodate the asymmetry issue caused by the inclusion of the alignment/orientation magnet. In the first stage, only the left handle moves until the magnetic ring is centered. In the second stage, both the left and right handles move together, and the magnet ring stays centered. This could be done in multiple ways. One way is to have the handles actually open symmetrically, but the magnet ring would “stick” to the right handle with magnets until a catch connected to the left handle pulls it away (after the magnetic ring became centered).

Other mechanisms are possible. For example, as shown in FIG. 12C, dual rack and pinion mechanisms 611, 612 with different gear ratios between the left and right sides of the island 610 of the magnetic connector can be used. Because of the different gear ratios, the user would feel as if he is pulling the left- and right-side handles 601, 602 of the game controller 600 away at the same time, but the distances actually moved by the left- and right-side handles 601, 602 would be different.

### E. Example Float Mechanisms

As mentioned above, in some embodiments, the magnetic connector in the game controller magnetically couples with a corresponding magnetic connector in a mobile computing device. In some situations, the corresponding magnetic connector is located in the center of the mobile computing device. So, locating the magnetic connector between the left- and right-side handle of the game controller would align its magnetic connector with the corresponding magnetic connector of the mobile computing device. However, the corresponding magnetic connector of some mobile computing devices may not be located in the center of those mobile computing devices (e.g., the magnetic ring is slightly off center in the iPhone Pro 13). In these situations, the magnetic connectors may not align and magnetically connect.

To address this situation, in some embodiments, the magnetic connector of the game controller (and, optionally, components coupled with the magnetic connector, such as the island or bridge assembly) can “float” (i.e., move due to magnetic forces pulling the magnetic connector of the game controller toward the magnetic connector of the mobile computing device) to automatically align the magnetic connector of the game controller with the magnetic connector of the mobile computing device. The float can be accomplished in any suitable way, it can occur in the X-, Y-, and/or Z-directions, and it can involve a certain amount of movement relative to other components of the game controller (e.g., only a slight amount of movement). The following paragraphs provide three examples that are described with reference to the example game controller 600 of FIG. 12A. It should be understood that these are merely examples, that these examples can be implemented with the other game controller configurations disclosed herein, and that other mechanisms can be used.

### 1. Floating the Magnetic Connector Island

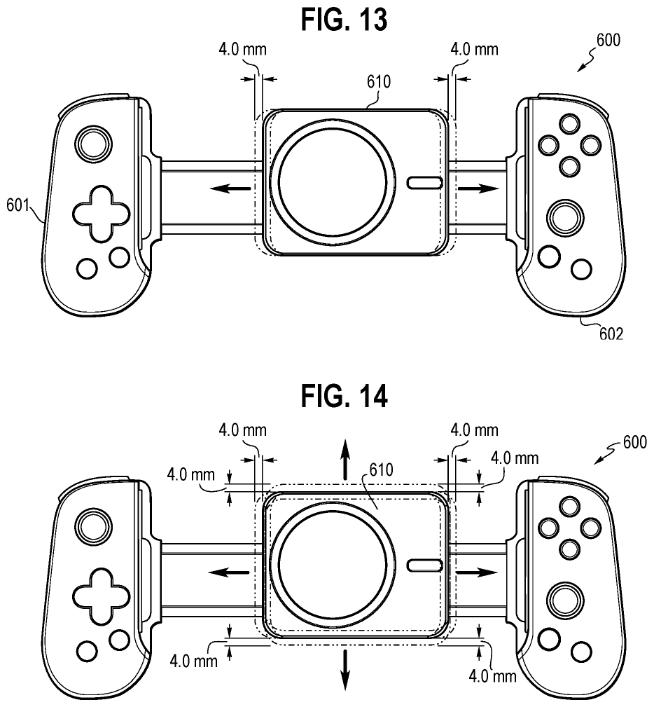

In one embodiment, the magnetic connector is fixed inside of the magnetic connector island, and the magnetic connector island is given a degree of freedom to float with respect to the bridge when the magnetic connector of the mobile computing device pulls the magnetic connector of the game controller towards it. In this embodiment, if the magnetic connector of the mobile computing device is not exactly co-located with the magnetic connector of the game controller, the magnetic connector island can move, so as to co-locate the two magnetic connectors. An example of this embodiment is illustrated in FIG. 13.

As shown in FIG. 13, the game controller 600 allows the magnetic connector island 610 to move (and thereby “float”) up to about 4 mm (although any suitable distance can be used) toward either of the left- and right-side handles 601, 602. As mentioned above, such movement towards the left- and/or right-side handles 601, 602 is referred to herein as movement in the “X-direction.” In one example, the force required to move the magnetic connector island 610 is less than a shear force against the mobile computing device. Also, the movement can be silent, smooth, and dampened with rubber fittings and a soft stop. The bridge close/spring force can stop the movement.

In another embodiment (shown in FIG. 14), the game controller 600 additionally allows the magnetic connector island 610 to move (and thereby “float”) up to about 4 mm (although any suitable distance can be used) in a direction substantially perpendicular to the axis running between the left- and right-side handles 601, 602. As mentioned above, such movement is referred to herein as movement in the “Y-direction.” In yet another embodiment, the float is in just the Y-direction. Further, the game controller 600 may additionally or instead allow the magnetic connector island 610 to move (and thereby “float”) in the “Z-direction,” which is the axis substantially perpendicular to the axis of the Y-direction and running into the page when looking at FIG. 14.

Any suitable mechanism can be used to float the magnetic connector island. For example, the magnetic connector island can comprise a protrusion that rides within a slot oriented in the X-direction that allows the magnetic connector island to move, if needed. To provide float in the Y-direction, a slot oriented in the Y-direction can be used. To provide float in both the X- and Y-directions, a square-shape slot can be used that accommodates travel in both the directions.

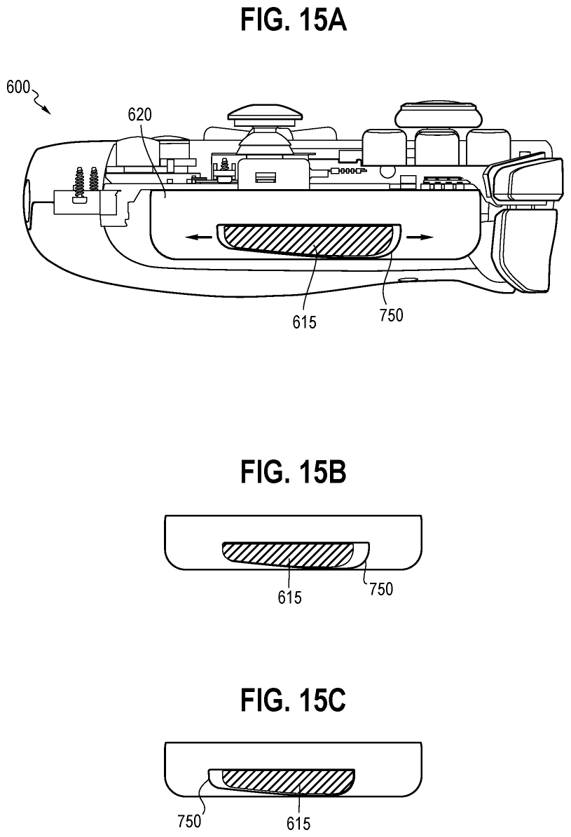

FIGS. 15A-15C are illustrations of another way in which the magnetic connector island 610 can float in the Y-direction. In this example, a gap/tunnel 750 is provided in the island 610 that is sufficiently sized around the bridge 615 to allow the island 620 to float in the Y-direction (here, by up to 4 mm in either direction). This allows the bridge to move inside the gap/tunnel 750, allowing the whole island to move up to 3-4 mm in each Y-direction because the bridge 615 is shorter than the island's gap/tunnel 750 height in the Y-direction. These two parts can interact/be assembled together to provide a light friction fit. If centering is desired, there can be a central coil spring having a given radius (e.g., ˜10 mm radius) that attaches the island to the bridge 615.

After the island floats, as appropriate, and the magnetic coupling between the mobile computing device and the game controller is complete, the user can push the grips until they make contact with the mobile computing device. The bridge extension/collapsing action is powered by user in this example, and the bridge stays in a given position when user stops applying a pull/push force. This can be achieved by a friction fitment method as part of the bridge extension mechanism/utility, where the bridge extension actuation is assisted by spring force. Once the bridge open trigger is actuated, the grips attached to the bridge arms can spring open, allowing the necessary gap for the mobile computing device to attach to the game controller magnetically. Once the magnetic coupling is complete, the user pushes the grips inwards until hard contact is made with the edge of the mobile computing device. During this travel of bridge collapse action, the bridge ratchets, stopping in evenly- or unevenly-spaced increments. These stop points may be based on exact dimensions of compatible mobile computing devices or be evenly-spaced increments achievable by the mechanical system where the bridge open/close functions are assisted by springs while the spring force and travel distance is optimized to support mobile computing device of various dimensions.

### 2. Floating the Magnet in the Magnetic Connector Island

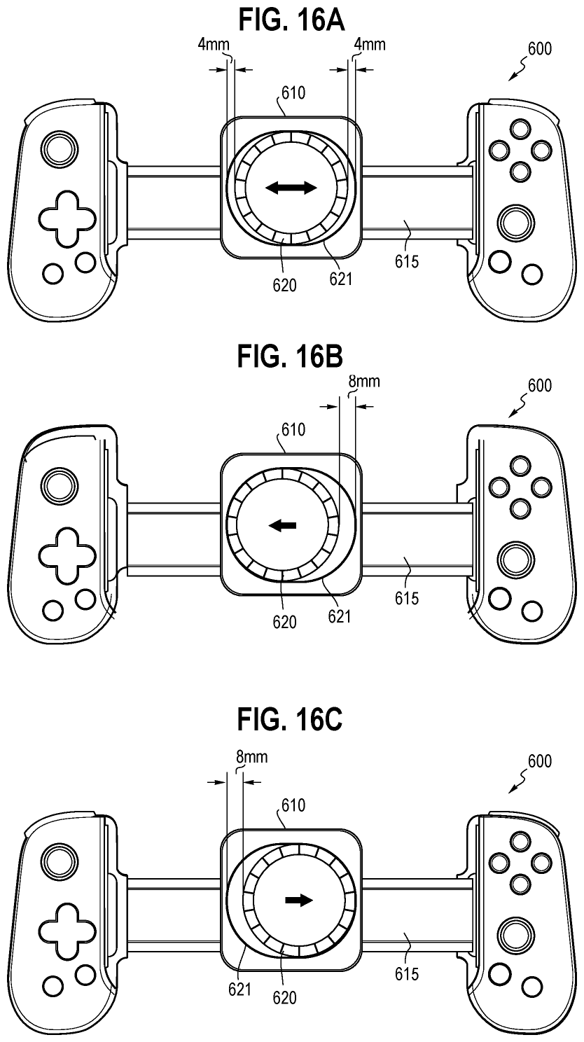

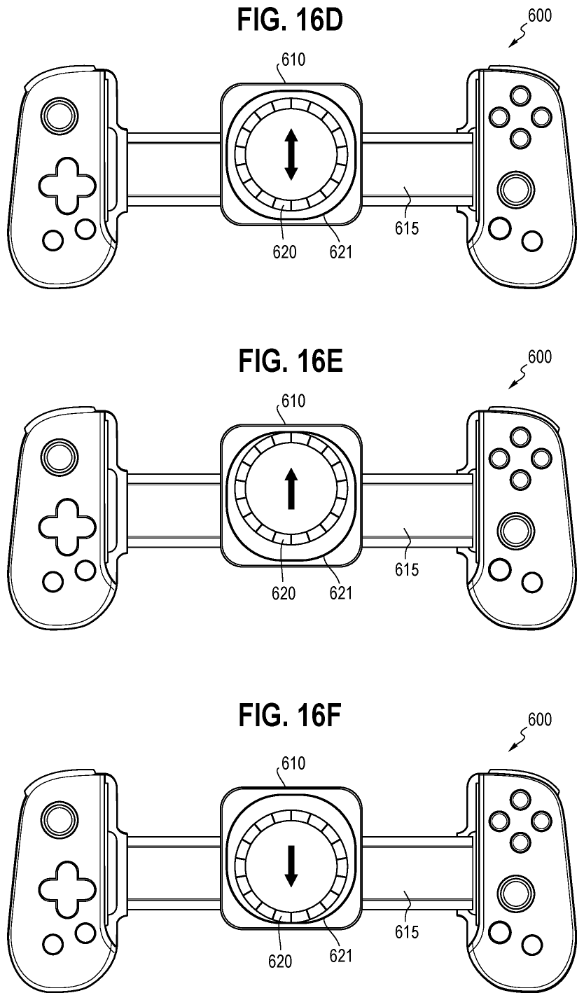

In another embodiment, instead of moving the magnetic connector island 610 of the game controller 600, the magnet connector island 610 is stationary (e.g., fixed with respect to the bridge), but the magnetic connector 620 (e.g., ring array) inside the magnet connector island 610 floats relative to the island 610. In this embodiment, the travel of the magnetic connector 620 is not visible to the user since the travel happens inside of the housing of the magnet connector island 610. Examples of this embodiment will now be described in conjunction with FIGS. 16A-16F.

In the example shown in FIGS. 16A-16C, the magnetic connector 620 is movable along a slot 621 oriented in the X-direction to allow for float in the X-direction. FIG. 16A shows the magnetic connector 620 centered in the slot 621 with 4 mm of float space on either side of the magnetic connector 620. FIG. 16B shows the situation in which magnetic forces created due to the presence of a mobile computing device (not shown) cause the magnetic connector 620 to move toward the left handle of the game controller 600. Similarly, FIG. 16C shows the situation in which magnetic forces created due to the presence of a mobile computing device (not shown) cause the magnetic connector 620 to move toward the right handle of the game controller 600.

While FIGS. 16A-16C show the slot 621 oriented in the X-direction to allow for float in the X-direction, additionally or alternatively, the slot 621 can be oriented in the Y-direction to allow for float in the Y-direction. For example, FIGS. 16D-16F show that the slot 621 can be configured in a square shape to allow for float in the X-direction (as in FIGS. 16A-16C), as well as in the Y-direction, as shown in FIG. 16D-16F.

### 3. Moving the Bridge to Float the Magnetic Connector Island

In yet another embodiment, instead of moving the magnetic connector island with respect to a stationary bridge or moving the magnetic connector relative to the magnetic connector island, the bridge itself moves to float the magnetic connector island and the magnetic connector along with it. In this way, the island-bridge assembly moves relative to the handles of the game controller. This embodiment has the advantage of being relatively less complex and less expensive to implement mechanically, being relatively more reliable, and providing a transparent experience to users.

The island-bridge assembly can move in any suitable way. For example, as shown in FIGS. 17A-17H, in one embodiment, the shaft 650 of the pinion gear 660 (which links the handles 601, 602 to the island-bridge assembly 610/615 via racks 670, 680) is a moveable element. Allowing the shaft 650 to move left and right in the bridge 615 provides a way for the entire island-bridge assembly 610/615 to shift relative to the handles 601, 602, which is a mechanically-simple and robust solution. In FIGS. 17A-17B, the island 610 is centered. In FIGS. 17C-17E, the island 620 is shifted to the left, whereas, in FIGS. 17F-17H, the island 620 is shifted to the right.

Instead of using a pinion gear, a different component that links the handles 601, 602 relative to the bridge 615 can be used. For example, the link can be done with a belt system that is part of a rack-and-pinion gear mechanism but instead of having two linear and stiff gear racks, a gear belt rack is used. This embodiment is shown in FIGS. 18A-18B. In this embodiment, the belt 700 comprises gear rack pins 710, 720 that are movable in slots 675, 685 in the racks 670, 680. Gears 701, 702 move the belt 700, and the space provide by the slots 675, 685 allows the pins 710, 720 to move freely in the slots 675, 685 to float the island in the X-direction (the width of the slots 675, 685 limits the X-float amount). So, in this example, the attachment to the belt gear rack has a “dead-zone” slot where the island can move to achieve X-float.

Various other mechanisms can be used as well. FIGS. 18C-18Y show examples of these various mechanisms. It is important to note that these are merely examples and that other implementations can be used.

Turning now to those drawings. FIGS. 18C-18K show a game controller 800 of an embodiment. The game controller 800 comprises left and right handles 801, 802, a magnetic connector island 810, and a bridge 815. In this example, the magnetic connector island 810 houses part of a tunnel 820 (see FIG. 18H) that the bridge 815 retracts into. As shown in FIG. 18E, the handles of the game controller 800 (the left handle 801 is shown in this figure) houses another tunnel portion 821 for the bridge 815 to retract into. As shown in FIG. 18I, this results in right and left tunnel areas 824, 826.

As mentioned above, a static hold method can be used. In the static hold method, the bridge 815 is extended by user push and pull forces by moving the friction-fitted bridge 815 with bridge ends captive inside the magnetic connector island 810 and the left and right handles 601, 602. FIG. 18J shows placement of the friction filament 830 in this example. This filament works similar to some headband adjustment mechanisms, as shown in FIG. 18L. The static hold method can be used with other configurations of the game controller. For example, this method can be used with a game controller 840 (see FIG. 18M) that uses a telescoping mechanism, a game controller 842 (see FIG. 18N) that uses a dual rack-and-pinion extension, and a game controller 844 (see FIG. 18O) that uses a gear belt and rack extension.

Also, the static hold method can be used independently from the bridge opening method. (Float action can be independent from the bridge-opening method, which is related to the embodiment described herein with upper and lower island sections.) For example, in the game controller 850 shown in FIGS. 18P-18R, the magnetic connector island 860 is divided into an upper section 861 and a lower section 862, where the upper section 861 can float and the lower section 862 houses the tunnel and HWEE (i.e., hardware electronics, such as printed circuit boards populated with components that make the system work). FIGS. 18S-18V show that the game controller 850 can have a “racetrack”-shaped slot 870 that allows the upper section 861 to float in the X-direction with respect to the lower section 862. Also, as shown in FIGS. 18W-18X, the game controller 850 can have a square (or other shaped) slot 880 that allows for float in both the X- and Y-directions (e.g., any cardinal direction). Additionally, as shown in FIG. 18Y. The game controller 850 can have a self-centering coil spring 890 that causes the upper section 861 to return to the center position. In this example, the magnetic connector's magnetic strength can defeat the spring's resistance.

In another embodiment, the float can be achieved by independently extending grips without a rack-and-pinion mechanism. This can be compatible with both force-close and static-hold methods. Examples of this embodiment are shown in FIGS. 18Z1-18Z2. The drawings show a static island-independent handle, specifically how decoupled handles and a static island can accommodate mobile computing devices with non-centered magnetic connectors (in X).

### F. Examples of Additional Retention Mechanisms

As noted above, if the magnetic field is strong enough, the magnetic connector can, by itself, retain the mobile computing device onto the game controller. However, relying solely on magnets as a retention mechanism can be expensive, so additional mechanical features (e.g., left/right side capture or clamping features) of the game controller can be used to retain the computing device in place (at least in the X- and Y-directions, as the magnet may provide sufficient retention in the Z-direction.

Also, an alternative docking mechanism called “Y-bridge docking” can also be used, where the bridge-open function can work similar to the force-open method except the bridge is opening on the Y-axis and the mobile computing device is clamped from top and bottom. Device docking can be with or without magnets in such scenario. The grips can slide out like drawers, so that the game controller input surfaces are exposed and are accessible by the user. The drawer mechanism may be on a bi-stable spring actuation or friction-based static-hold method or a combination of methods where the opening is assisted by springs, but the closing is user powered. The drawer push open actuation can be triggered by the magnetic attachment of the phone (e.g., the grips push open when the mobile computing device is docked). The same function also has hooks in hardware electronics with pairing/seeking mode actuated by a docking sequence, as discussed below. Also, the folding arms of a bridge can be at X, Y lengths to achieve the desired bridge gap for device fitment.

### G. Example Solutions for Addressing Pinch Points

Depending on the configuration of the back of the game controller, the position of the magnetic connector island can create a pinch point where the user's finger(s) can get caught in between the handle and the magnetic connector island. One solution to this pinch point problem is to move the bridge further down, which would prevent this issue (but possibly hamper ergonomics). Another solution is to add dampening to the end of the range when the handles snap closed. As yet another solution, more radius can be added to the corners of the magnetic connector island (e.g., a rounded rectangular platform that eventually converges to a circular shape in the center) to provide adequate “keep outs” for the user's fourth and fifth fingers.

Additional possible solutions include, but are not limited to, raising the computing device in the Z direction, allowing more distance from the computing device to the handle in the X direction, allowing the computing device to tilt away from the user, widening the bridge in the Y direction, moving the computing device closer to the top of the game controller, modifying the shape of the holder in the areas where the computing device may tend to pop out (e.g., refining contours or introducing adjustments to enhance grip and stability to provide a more-secure fit), allowing for flexibility or movement in the Z direction while still maintaining a secure connection to absorb small impacts or vibrations during gameplay which can reduce the chances of accidental phone dislodgement, providing silicone bumpers or pads around the around the edges of the magnetic connection area to act as shock absorbers and provide a buffer to prevent unintended Z-axis movement or dislodgement caused by sudden impacts or jolts, reinforcing the bottom support of the game controller where the computing device rests (e.g., using a raised lip, rubberized grips, or additional material to provide stability and prevent accidental phone-popping during gameplay), providing reinforced corners or edges to provide added support and prevent Z-axis movement and act as a barrier against accidental dislodgement, adding a curved or concave holder for the computing device that matches the natural curvature of the computing device to reduce the chances of Z-axis dislodgement during gameplay, and using foam for comfort on the game controller.

### IV. Example Connect/Play Techniques

As noted above, in addition to serving as a retention mechanism, the magnetic connector can be used to communicate data between the game controller and the mobile computing device. In one example embodiment, this communication is used to provide a fast connection between the game controller and the mobile computing device. In this way, the magnetic connector can create a seamless attachment between the game controller and mobile computing device and provide a fast ready-to-play experience. Reducing the upfront time (the “delay to play”) and effort for a user to set up the game controller to play a game on the mobile computing device can increase the likelihood of a user using the game controller. For example, the user can simply place his mobile phone on a magnetic connector of the game controller and very quickly (e.g., in seconds) start playing a game.

In one example embodiment, the magnetic connector of the game controller is used to transfer keys between the game controller and mobile computing device to pair the devices (and, optionally, for power transfer, as discussed below), and a wireless communication channel such as a Bluetooth channel is used to exchange data for gameplay. More specifically, near-field communication (NFC) can be triggered as the game controller is placed in proximity to the mobile computing device during the attachment process. This can trigger downstream activities (e.g., waking up/transitioning from idle mode to low-power mode, pairing, app launch, etc.) on the mobile computing device to ensure the mobile computing device is in a ready-to-play state automatically. (Conversely, when the mobile computing device is removed from the magnetic connector, the gaming app, etc. can be closed or hidden on the mobile computing device.) In this example, Bluetooth sustains the continued inputs of the game controller to the mobile computing device for low-latency gameplay (e.g., by relaying the continued inputs from the game controller to the mobile computing device via a Bluetooth communication channel. Bluetooth can also provide wireless output of audio from the mobile computing device to an audio output device (e.g., headphones, an external speaker, etc.).

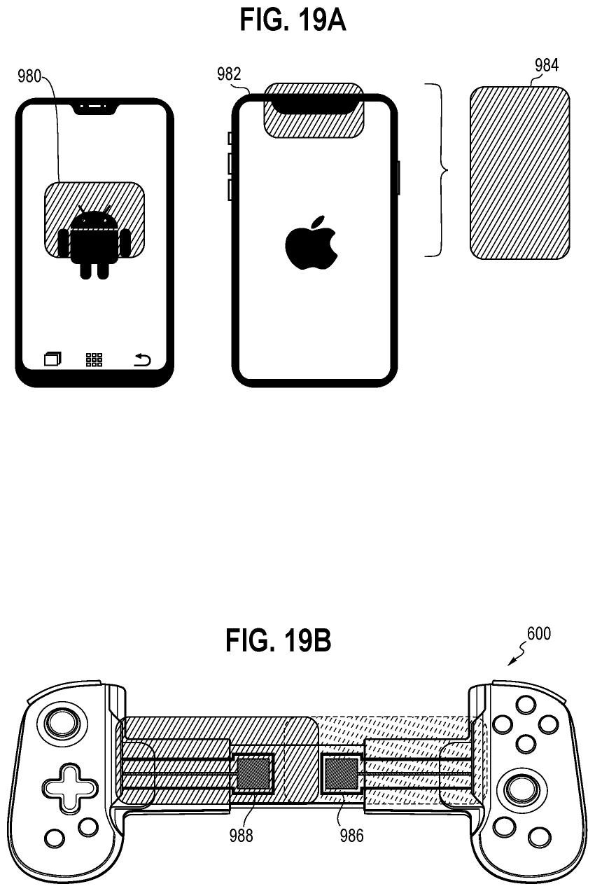

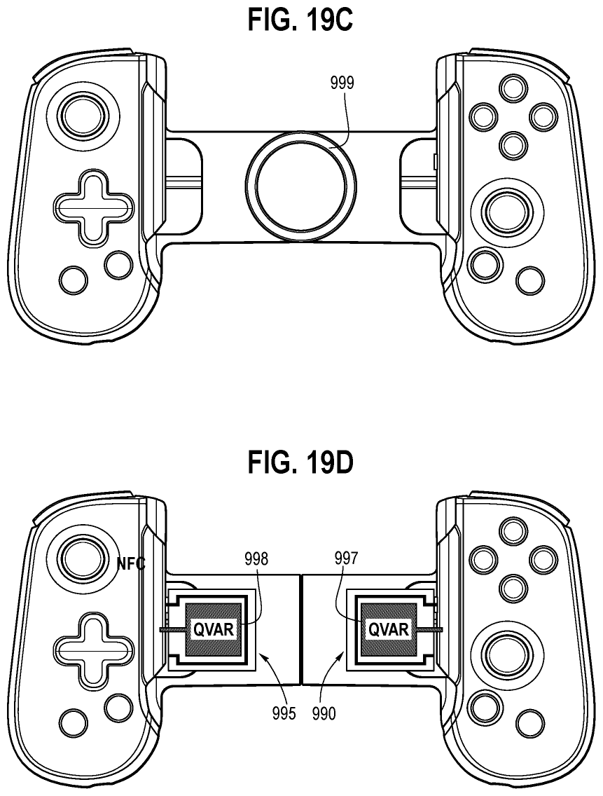

As illustrated in FIG. 19A, to accommodate different types of mobile computing devices (here, an iPhone and an Android phones) that have their NFC antennas 980, 982 in different locations, the NFC antenna 984 in the game controller can be made large enough, so as to be co-located with either location. Also, some mobile devices can be oriented in multiple directions, and it may be desired to provide antenna co-location in either orientation.

Typically, the NFC tag antenna has to be close to the reader antenna in order to be powered and communication to be established. Because there are many devices targeted for compatibility with the game controller, the NFC tag antenna would have to span the entire surface area of the devices attached to the controller. One way around this is to use the fact that the game controller of some embodiments, as part of being a form-fitting device, stretches to accommodate many different devices. For example, as illustrated in FIG. 19B, as the game controller 600 stretches, the built-in NFC antennas 986, 988 pass by a larger area of the mobile computing device's back than the antenna's size. This allows brief contact, but it would be enough to wake the controller and pass some data.

Further, a dual NFC antenna may be desired if there are functionalities (e.g., authentication, wake-up, and communication for Bluetooth pairing, etc.) that a single NFC tag may not be able to accomplish. Also, as noted above, mobile computing devices can have different NFC locations and, in some cases, multiple readers, and a single NFC tag may not be able to communicate in every situation. FIG. 19C illustrates an embodiment that addresses these issues by using a central, co-centric, dual NFC antenna 999. FIG. 19D illustrates another embodiment with a pair of dual NFC antenna 990, 995. When dual antenna are used, chips of differing abilities can be connected to each antenna. While both chips may receive a signal from the reader, the chip with the correct features can reply and establish a communications path.

FIG. 19D also shows electric charge (Q) variation (“QVAR”) chips 997, 998. QVAR is a way of detecting when a device is mounted on the game controller. It uses a change in capacitance of an antenna to detect the presence of a foreign object. This technology can function through a housing and can be completely hidden. Alternate ways include ultrasonic sensing, IR sensing, detecting magnetic fields, or the previously-described NFC solutions. This signal can be used to trigger pairing, communications, power on, etc. When a mobile computing device is removed from the game controller, the device can power off, disconnect, etc.

It should be noted that some mobile computing devices (e.g., iPhones) may use a magnetic connector (e.g., MagSafe) that has a separate NFC coil that does not tie into the system's NFC functionality but is used for authentication purposes. That NFC coil may be in the middle of the phone. Typically, the authentication chip (which has the NFC chip embedded in it) may not be used for general-purpose NFC communications.

### V. Example Power Management and Power Handling Techniques

As noted above, in some embodiments, the game controller has one or more batteries and has the ability to charge the one or more batteries when the game controller is plugged into a charging device (e.g., a wall outlet, a USB outlet of a laptop or a portable battery, etc.). The game controller can also have the ability to charge a battery of a mobile computing device used with the game controller (e.g., through a wired connection or wirelessly via a Qi charger) when the game controller is plugged into a charging device or, optionally, off of the battery of the game controller, when the game controller is not plugged into a charging device. The following paragraphs provide example techniques that the game controller can implement for power management and/or power handling.

### A. Example Hardware Configurations

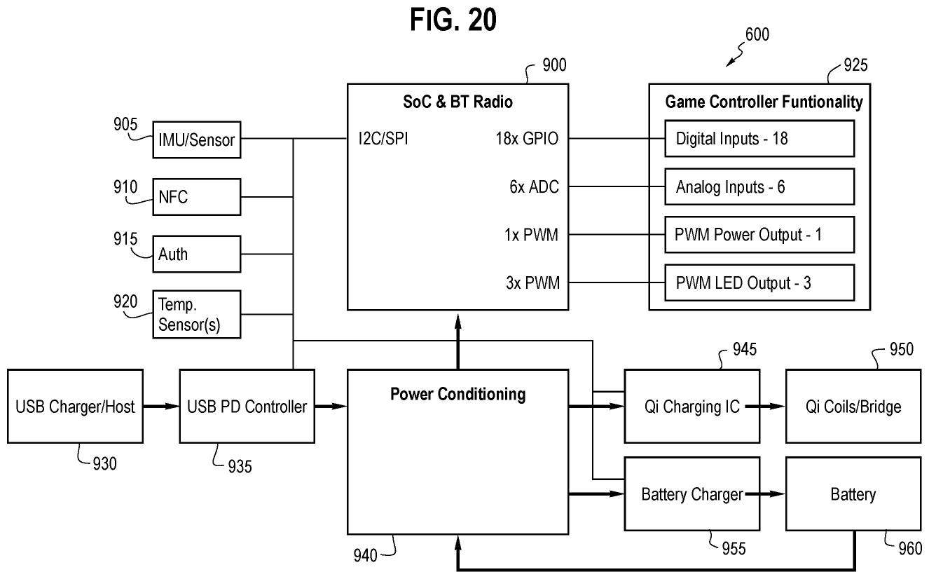

Turning again to the drawings, FIG. 20 is a block diagram of an example game controller of an embodiment showing various example hardware components. As shown in FIG. 20, in this example, the game controller 600 comprises a system-on-chip and Bluetooth (SoC & BT) radio 900, which can communicate with the mobile computing device via Bluetooth to exchange various data. The SoC & BT radio 900 can comprise at least one processor and at least one computer-readable medium (e.g., memory) to store computer-readable program code for execution by the at least one processor. The game controller 600 in this example also comprises an IMU/sensor 905, one or more NFC chips 910, an authentication (“auth”) chip 915, one or more temperature sensors 920, a game controller functionality block 925 comprising various input/output elements, a USB PD controller 935 (which communicates with an external USB charger/host 930), a power conditioning module 940, a Qi charging integrated circuit 945, Qi coils/bridge 950, a battery charger 955, and a battery 960.

The bottom half of the diagram is the power path. The bold arrows are power flows, while the thin arrows are bidirectional information busses. The game controller functionality block 925 describes a basic game controller with analog inputs (such as triggers, joysticks, etc.), digital inputs (such as face buttons, control buttons, etc.), a power output, and an LED output. More or fewer inputs/LEDs are possible. The SoC & BT radio 900 is used for the main control of the game controller 600 and communications to the host computing device. The SoC & BT radio 900 connects to various components and gathers data. The SoC & BT radio 900 can perform balancing of power between charging the battery 960, running the system, and using Qi to charge the host computing device.

The IMU/sensor 905 is used to detect usage of the game controller 600. Any suitable method of detecting usage can be used, and, in some embodiments, the IMU/sensor 905 can be used to inform power state decisions. Among the types of components that can be included in the IMU/sensor 905 are IMUs, accelerometers, QVAR sensors, bridge-open detect switches, IR sensors, ultrasonic sensors, radar, etc. The NFC chip 910 can be integrated in the magnetic connector (e.g., MagSafe) or can be an independent antenna that can be used for pairing as well as to inform when a device is connected to the game controller 600, among other possible functions. The auth chip 915 is used if there is authentication for proprietary communications or to authenticate firmware updates.

For power, in one embodiment, an external USB PD controller 935 can be used to provide enough power for the battery 960 and Qi charging IC 945, as well as the system. The USB PD controller 935 can useBC1.2, the general USB1.0 standard and later, or proprietary interfaces, such as Qualcomm Quick Charger and those used by Samsung, Apple, and other companies. The power can be conditioned and distributed to the system by the power conditioning module 940. The input power can be at any suitable voltage (e.g., 5V, but other systems may require different voltages). In one example, the Qi wireless power transmitter 950 may require 9V or 15V constant voltage, while the battery 960 is charged at 3.6 . . . 4.2V, and the system may need voltages between 1.2V and 5V to function.

The battery charger 955 can be used to charge and condition the battery 960 of the game controller 600. It can also be used to keep track of charge and discharge currents for a State of Charge monitoring or Coulomb counter. Power from the battery 960 can be used to supply power to the game controller 600 when power from an external source is not available. In some embodiments, the battery 960 can also be used to power the Qi charger 945, which can in turn be used to supply power to the mobile computing device attached to the magnetic connector via the Qi coils/bridge 950 Both the Qi coils/bridge 950 and the battery charger 955 can be controlled by the SoC & BT radio 900. The SoC & BT radio 900 uses the USB PD controller 935 to determine the available power from the battery 960, then uses its control of the battery and Qi chargers 955, 945 to distribute power as deemed most appropriate for the system at the time.

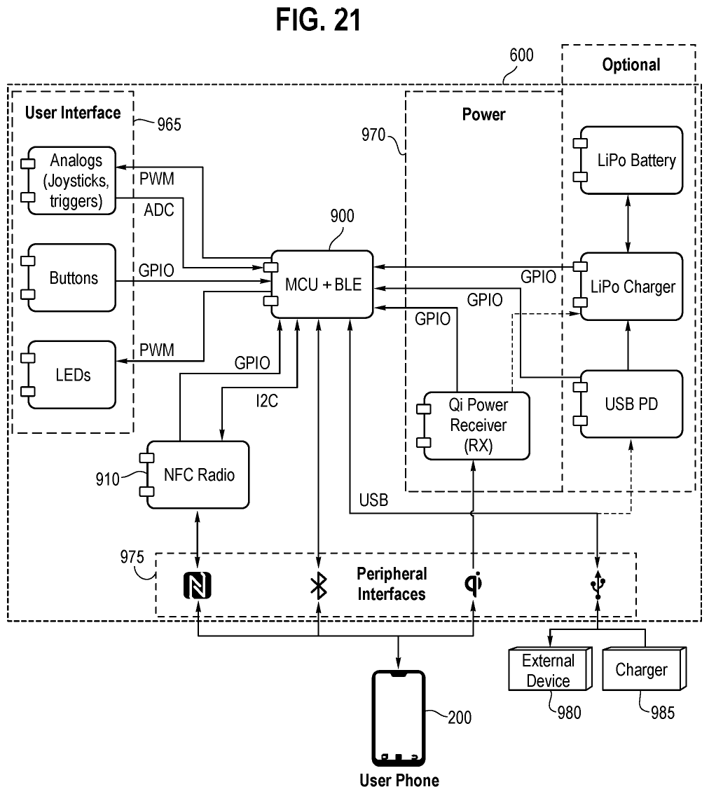

Turning again to the drawings, FIG. 21 is another block diagram of other example components in the game controller 600. As in the block diagram presented in FIG. 20, the game controller 600 comprises the SoC & BT radio 900 (here, noted as MCU (micro-controller unit) +BLE) and NFC chip 910. The other components, some of which are common to FIG. 20, are grouped into a user interface section 965 and a power section 970. FIG. 21 also shows that the game controller 600 of this embodiment comprises a peripheral interface section 975 that comprises a plurality of interfaces to exchange data between the game controller 600 and the mobile computing device 200 for game play and/or exchange power between the game controller 600 and the mobile computing device 200. The interfaces to the mobile computing device 200 can be wireless (e.g., Qi, Bluetooth, and NFC). In one possible implementation, Qi can be used to provide power from the game controller 600 to the mobile computing device 200, NFC can be used to establish a secure connection, and Bluetooth can be used for high-speed data communications, but various other implementations and uses of wireless interfaces are possible as well.

Also, a USB interface is used to connect the game controller 600 with a charger 985, as well as with an external device 980 (e.g., a laptop, a tablet, a TV, etc.) to allow display of a game on a device having a larger display than the display on the mobile computing device 200. This functionality is sometimes referred to herein as “play on any screen (POAS)” and is described in more detail in U.S. patent application Ser. No. 18/214,917, filed on Jun. 27, 2023, which is hereby incorporated by reference.

A USB host can interface with the game controller 600 through its USB connection. There are two main functions provided by the USB. First is to provide the game controller 600 with power from the host. This may be a simple 5V, 500 mA from the host, as defined in the USB interface specification. A more-advanced host may be capable of USB-PD and negotiate the voltage and current the host is capable of delivering versus the voltage the game controller 600 is capable of receiving. The second USB function is communication. The game controller 600 can present as a USB game controller to a host connected over USB. Much as it would with a wireless interface, human interface device (HID) messages can be provided to the host to describe the input surfaces of the game controller 600 for processing by the host. This allows the game controller 600 to be used with devices that cannot use the other wireless protocols.

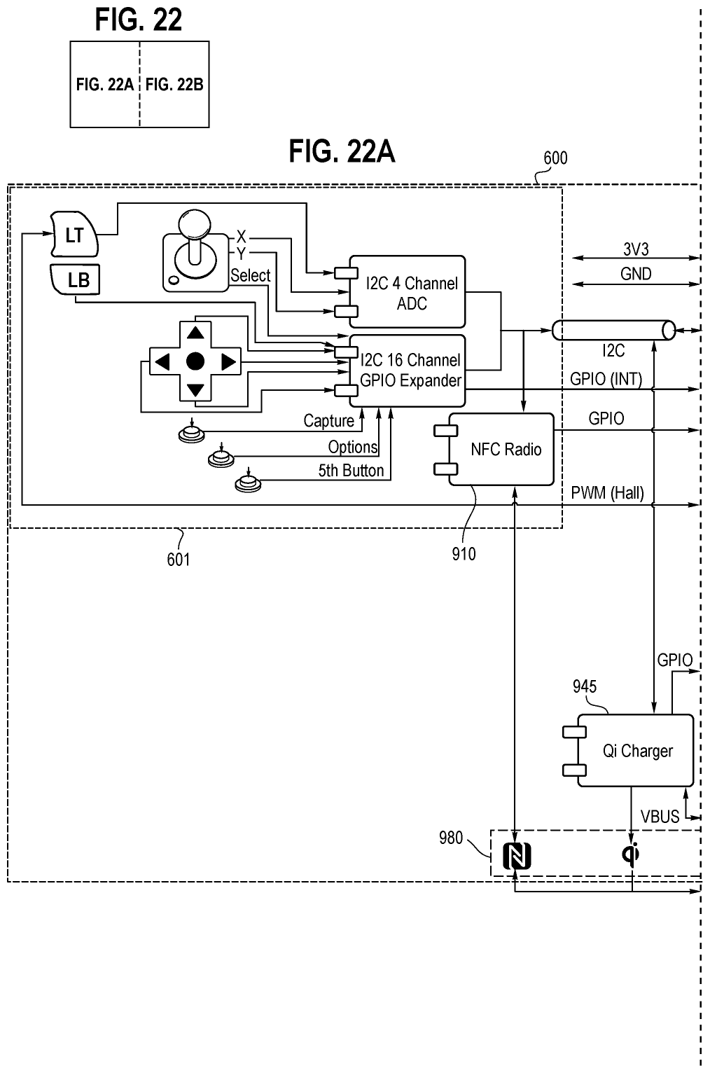

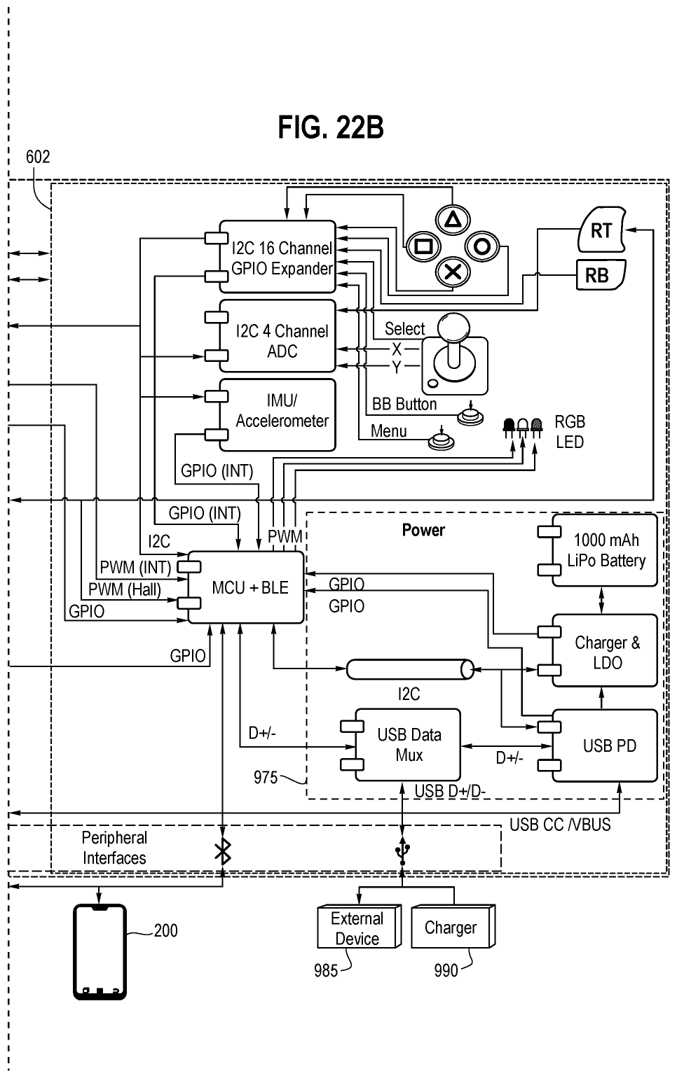

FIGS. 22A and 22B are more-detailed versions of the diagrams discussed above. As shown in FIGS. 22A and 22B, in this embodiment, some of the components are located in the left handle 601, while other components are located in the right handle 602. In this embodiment, the NFC chip 910 is in the left handle 601, and the Qi charger 945 and Qi coils/bridge 950 are in the center. The other components of the power system 970 (e.g., the USB PD, and LiPo battery) are in the right handle 602. It should be noted that this is merely one configuration and that other configurations can be used.

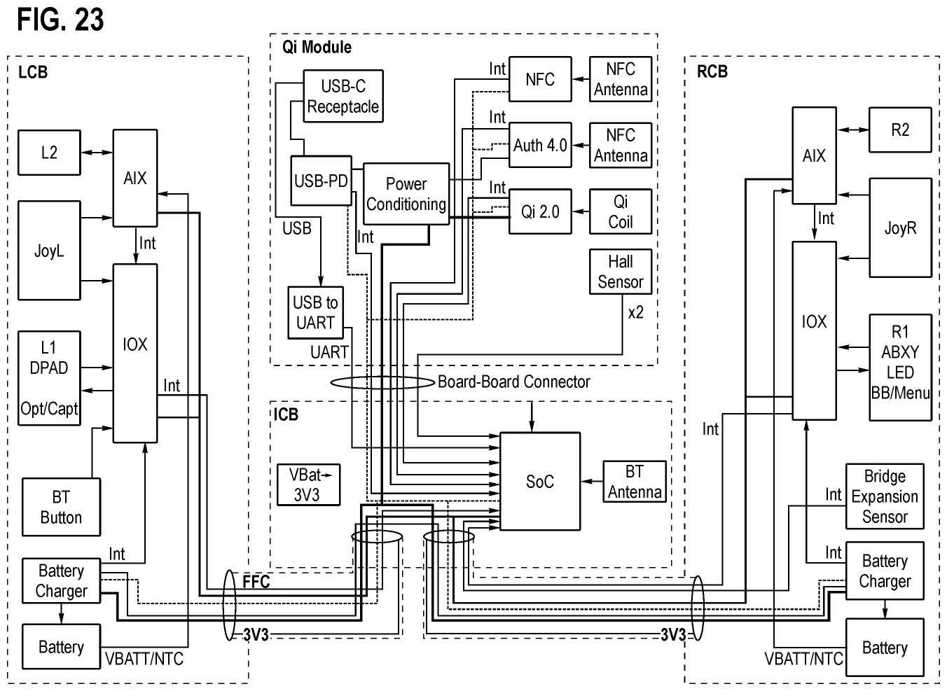

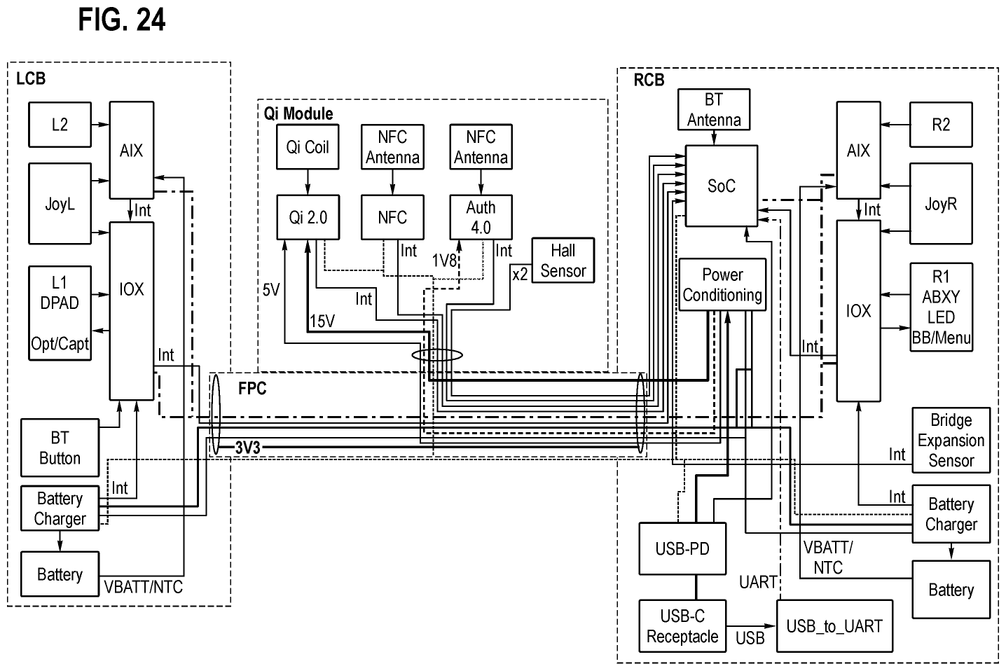

FIGS. 23 and 24 are additional example block diagrams. These diagrams show various components, including, but not limited to an AIX (analog input expansion chip (ASIC)), an IOX (an input/output expansion chip (ASIC)), an SoC (system on chip-main processor/radio), a UART (universal asynchronous receiver/transmitter) using an embedded serial communications protocol), and an NTC (negative temperature coefficient resistor (temperature sensitive resistor)).

FIG. 23 relates to a “square design,” in which the USB interface, SoC, and Qi modules are co-located in the center of the game controller. (As mentioned herein, wireless power transmitters other than Qi (such as MagSage) can be used.) Most of the power conditioning happens close to the Qi module. The SoC is physically separated from the Qi module by a board-to-board connector. This establishes a secure connection but removes the Bluetooth antenna from inside the magnet ring and reduces interference from Qi and NFC. There are two batteries and chargers in this design, though there can also be a single charger for two or more batteries, or there can be a single charger and single battery. The batteries can be located in such a way as to balance their weight with the game controller. However, weights can be used to establish a balance. Also shown in this block diagram are the flat flexible cables (FFCs) used to connect the left and right handles to the center, although a flexible printed circuit (FPC) can be used instead.

FIG. 24 relates to a “circle design,” in which the USB, SoC, and power conditioning elements are located in the right handle. Conditioned power is delivered to the Qi module in the center. This allows for a smaller Qi module. Analog and digital input-output (IO) expanders are used so many of the signals do not have to be routed across the controller (e.g., by an I2C or SPI bus).

### B. Example Power Management Techniques

In general, electrical control over the various subsystems discussed above allows the subsystems to be turned on or off depending on need and available power. These subsystems can include, for example, a Qi 2.0 system (as noted above, wireless power transmitters other than Qi (e.g., MagSafe) can be used), a USB-PD chip, a battery charger (e.g., if that is not also used to monitor battery charge or to condition power), an auth 4.0 chip, and/or Hall Effect sensors. In one example implementation, power management code with different sleep states can enable 40 hours of run time and several months of sleep time. Further, deep sleep power may be able to last at least six 6 months (4,368 hours) when 80% charged. This results in <180 μA standby current (assuming 1000 mAh). Active can last at least 40 hours when 100% charged, which results in 25 mA active current (assuming 1000 mAh). It may be preferred that charging should not hinder gameplay or usage of any features.

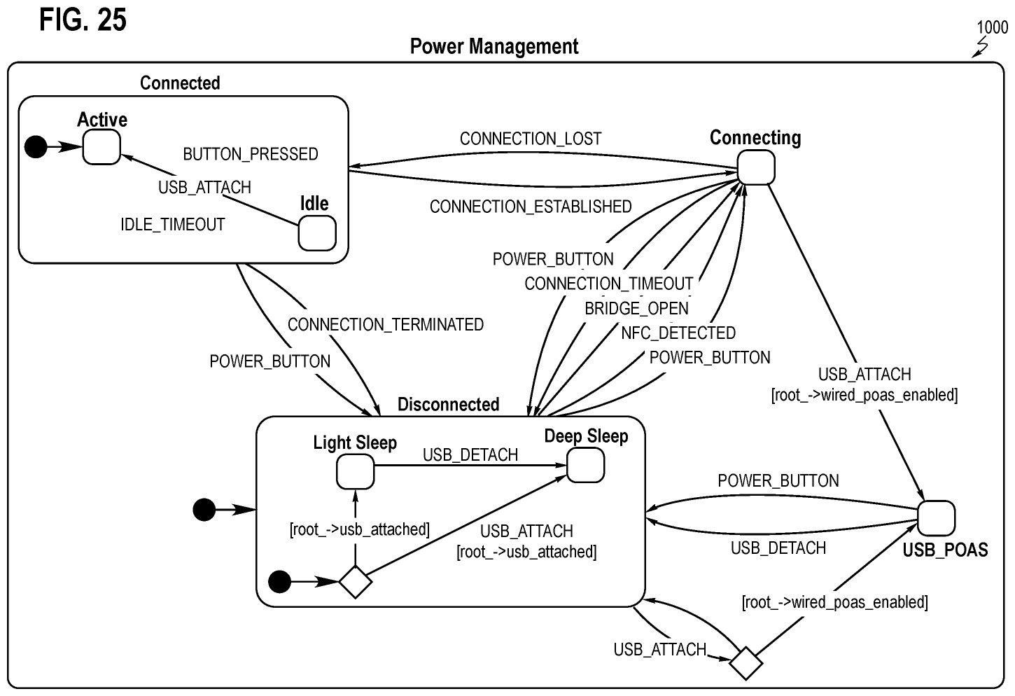

Turning again to the drawings, FIG. 25 is a power state diagram 1000 of a power management method of an embodiment. This diagram is a hierarchical finite state machine where the nesting of states is a simplification to indicate that any transition from the parent state to another state is also valid for any of the parent's children/subtree, and the entry into a state goes through its initial state marker (the black dots). This power management hierarchical finite state machine (HFSM) represents the radio power in various different states of the device. In the disconnected state, the radio is off, and the main processor can be in one of two sub-states: light sleep (when a USB cable is plugged in and the game controller is charging—light sleep is used to manage the LED/charging indication), and deep sleep (where the processor is in its lowest power mode). In the USB_POAS state, the radio is off because the controller is connected to a device and sending game controller data via HID over USB. When the user wants to connect (either manually or automatically) the HFSM transitions into the connecting state in which the radio is on and advertising/ready for a connection from a remote device such as a mobile device or computer. If the connection is established, then the HFSM will transition into the connected state. While in the connected state the power is managed between two sub-states: active (in which the radio and processor run at a higher frequency for low latency input response), and idle (in which the radio and processor run at a lower frequency to conserve power since—this state is used if “idle” conditions are detected based on various measured inputs such as no buttons pressed for a certain amount of time, motion measured by a sensor such as gyroscope, accelerometer, or IMU more generally is below a certain threshold, or potentially even a command from the mobile device's application—e.g. telling the game controller that a game is not active on the device, therefore the lower latency mode is not needed). The events and guards on the transitions in this diagram are intended to be explanatory and not exhaustive.

### C. Example Power Handling Techniques

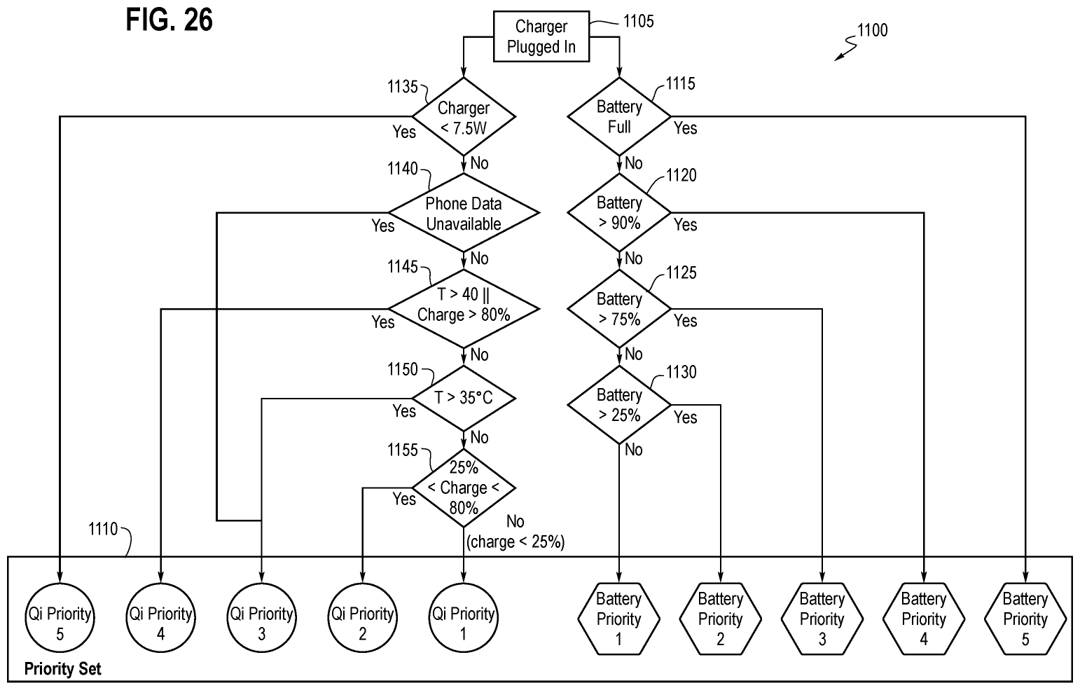

Turning again to the drawings, FIG. 26 is a flow chart 1100 of a power handling method of an embodiment. In this embodiment, after the game controller is plugged-in to a charging source (1105), one or more processors (e.g., in the SoC) in the game controller execute computer-readable program instructions to determine an internal battery priority and/or an external battery priority from a priority set (1110) (the Qi priorities relate to providing power to an external device). For instance, the internal battery priority can be determined based on the amount of charge of the battery in the game controller (e.g., battery full (1115), battery >90% (1120), battery >75% (1125), or battery >25% (1130)). Further, the external battery priority can be determined based on (i) the power supplied by the charger (1135), and/or (ii) information about the mobile computing device, which can be communicated to the game controller by the mobile computing device (e.g., using the Bluetooth channel) and/or can be sensed or otherwise detected by the game controller itself. Such information about the mobile computing device can include, but is not limited to, when phone data is available (1140), the temperature of the mobile computing device (1145, 1150) (e.g., as sensed by the temperature sensor 920 of the game controller (see FIG. 20) or as communicated to the game controller by the mobile computing device using the Bluetooth channel), and/or the level of charge of the battery of the mobile computing device (1155).

Based on this information, the game controller determines a priority level for charging the internal battery in the game controller and/or a priority level for charging the external battery in the mobile computing device (e.g., from the priority set 1110). It should be noted that the priority levels are determined independently, but the actions that are taken afterwards can take both priority levels into account. So, while the internal battery does not affect the priority of the phone's battery, it changes how much power is allocated. In this way, priority levels can be thought of as a simplification of the state of the batteries, while the actions taken actually translate that into power balancing.

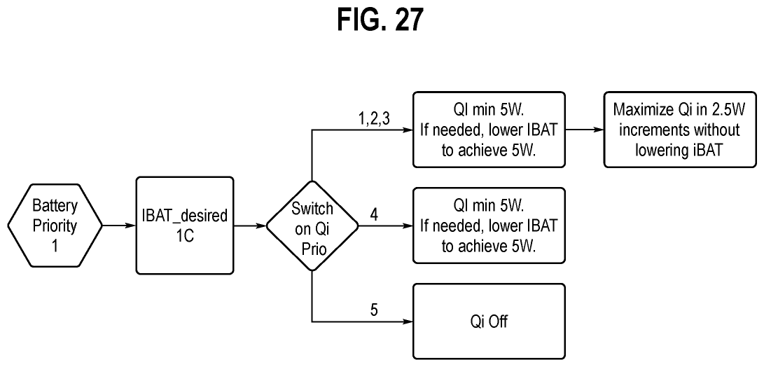

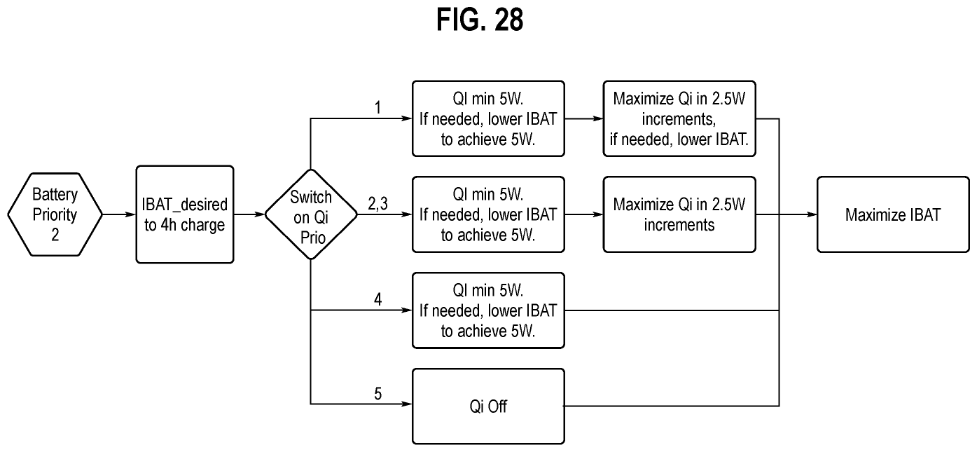

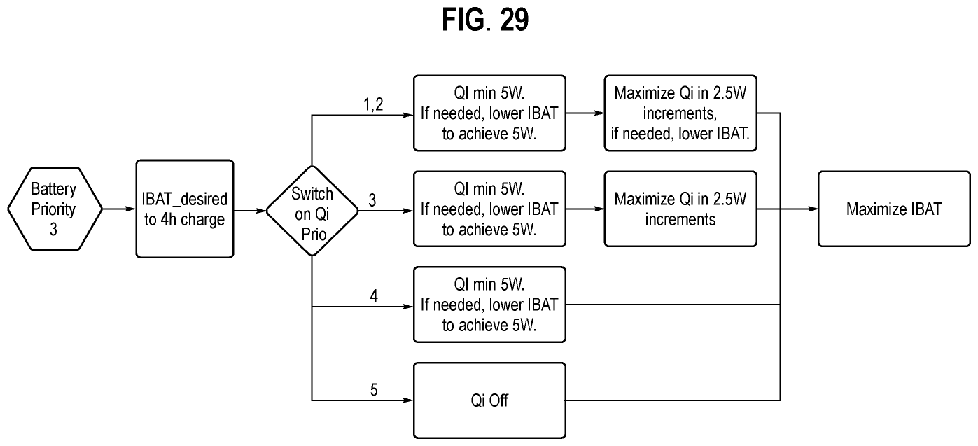

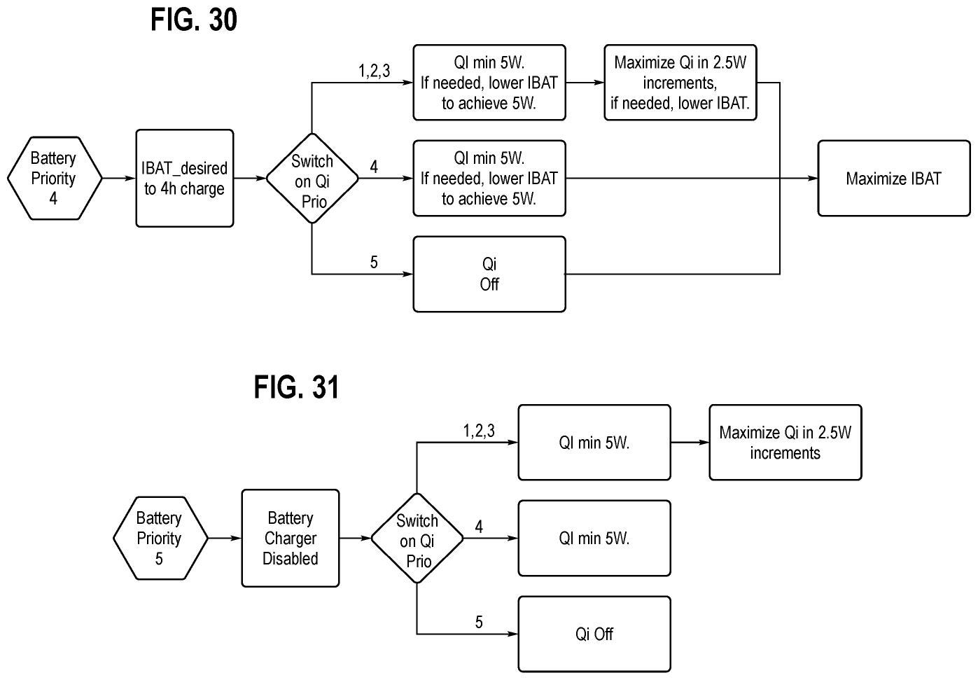

Based on the determined priority levels, the game controller can charge its battery and/or the battery of the mobile computing device according to associated parameters to distribute power received from an external source for such charging. In some situations, this can result in changing the game controller's battery but not the mobile computing device's battery, or vice versa. FIGS. 27-31 are flow charts that illustrate various power handling parameters based on battery priority levels 1-5, respectively. Of course, these are merely examples, and other implementations can be used.

### D. Additional Examples

The following paragraphs provide some additional examples of various power management/handling techniques.

In some embodiments, a battery is included in the game controller and provides additional power to the mobile computing device through wireless charging via the magnetic connector. Power management is provided to enable a more-optimal gaming experience. In some embodiments, power consumption by the game controller is minimized, so that the user can play for an extended time (e.g., up to an entire month in some instances) without having to charge the game controller. Power management can be performed by one or more processors in the game controller and/or by one or more processors in the mobile computing device (e.g., using an app running on a mobile phone).

In some embodiments, the game controller powers on when a mobile computing device is attached to the magnetic connector. For example, an accelerometer can be used to activate the Qi charger (or other wireless charging transmitter) after the user picks up the game controller (e.g., or after a time-out period in case the user puts the game controller down again). In another embodiment, an NFC chip in the game controller can wake up when a phone reader is trying to access the information in the tag.

This may indicate that a phone has been placed in the game controller. The NFC chip can then wake the rest of the system to let it know that a mobile computing device is present. However, in certain instances, this might require that the mobile computing device's NFC reader be powered on and active and that the NFC antenna in the game controller is within range of the mobile computing device's reader. MagSafe-type technology can simplify this since the mobile computing device's NFC reader is activated when the magnet ring is detected, and the NFC reader/tag has to be in range because the magnet ring also specifies location.

In some embodiments, the game controller detects when the bridge of the game controller is stretched to place a mobile computing device on the game controller. Alternatively or additionally, a button can be provided as a way to detect stretching of the bridge, but other types of mechanisms can be used, such as, but not limited to, using Hall effect and a magnet in the bridge.

In some embodiments, the game controller powers on when a button or other control element on the game controller is activated. For example, a button may be pressed and held down for some period of time (e.g., 600 ms). This option allows the game controller to support mobile computing devices that do not attach to the magnetic connector or to support instances when a connection failed with such a magnetic connector.

In some embodiments, the game controller radio and input functionality can be powered on/triggered remotely. For example, the game controller can have a near-field communications (NFC) receiver/transmitter such that when the user powers on an application on the mobile computing device that is associated with the game controller, the application performs out-of-band (OOB) communication with the game controller using NFC. Via this OOB communications link, data can be transferred unidirectionally or bidirectionally between the application and the game controller. As a result of this communication, the game controller can power on its radio—for example, a BLE radio—for the mobile computing device/application to connect to and start the game controller functionality of the device. Similarly, the game controller can be programmed such that plugging in the game controller for charging enables the game controller to detect communications from the mobile computing device that is transmitted as part of the charging process—such as that occurring within the wireless power transmission process implemented by Qi for example—to then turn on its radio and begin gamepad functionality as in the NFC case above. Note that in both cases, the information transmitted in the OOB communications link (NFC, charging, etc.) need not contain or be specific to the gamepad functionality for the activation of the radio and the gamepad functionality. Therefore, communications here could in some embodiments be simplified down into unidirectional interrupts from the OOB communications system to the game controller main processor and/or radio. Some of these OOB communications-such as NFC for example-can function completely without power from the game controller, relying entirely on the power from the communications link itself, and as such the power of the game controller can in these ways be controlled remotely.

In some embodiments, the magnetic connector is powered-off: (1) when a user can press and hold a button, (2) when a user removes the mobile computing device (e.g., where power off occurs after a period of time, such as a few second or a minute, in case user wants to put the mobile computing device on a mount, is checking messages, gets a call, etc. and then puts the mobile computing device back), (3) based on accelerometer and or button-press inactivity (e.g., after five minutes of inactivity) when the game controller is used as a Bluetooth (e.g., BLE) controller for external devices, (4) when the game controller is connected but inactive, (5) after the user disconnects Bluetooth, and/or (5) based on a command from an application on the mobile computing device.

There are several different power states that the game controller can find itself in. These can include, but are not limited to: (i) Active On—Connected to a host, the game controller measures and reports control inputs at the minimum BLE interval; (ii) Powered Off—the MCU is off, BT is off. The unit can be woken by the above methods (e.g., a button or NFC/Sensor generating a GPIO (general-purpose input-output) interrupt); (iii) Active Idle—BLE connected, but for various reasons, the game controller is not being used. Connection can be maintained at a slower interval (e.g., 100 ms) and inputs can be monitored for input to reduce the interval again. Eventually, the state can be switched to Powered Off; (iv) Connecting Idle or Startup—BLE advertising but no connection is established, digital inputs are monitored for input but analog can be powered down. Eventually, the state can be switched to Powered Off; and (v) Charging Idle—The plugs in the game controller for charging. No BLE connection is active, but the game controller is active to monitor battery charging, run LEDs, etc.

In some embodiments, the game controller comprises one or more light-emitting diodes (LEDs). In such embodiments, it may be desired that the LEDs be turned off as much as possible to conserve batteries. LEDs can be different between docked mode and free mode. In docked mode, it is known that the game controller is connected, and the battery percentage can be obtained on the mobile computing device.

The following are example states of an LED: (i) Power On—White fade on; (ii) Power Off—White fade off; (iii) Battery Power—Red or use colors to show state (e.g., full battery (when plugged in), charging battery, low battery, critical battery, shutting down due to battery; (iv) Bluetooth (pairing, connecting, connected); (v) Qi Charging (BPP (slow) charge, EPP/MPP (fast) charge, lost connection (not charging anymore); (vi) Play on any screen; and (vii) Another LED for capture button (e.g., red for standard record, yellow for smart record, green for screen sharing, purple for Twitch streaming, Flash for screenshot).

In some embodiments, pass-through charging is done from the game controller (with power coming from an external power source) to the mobile computing device. In one embodiment, wireless power is used to simultaneously charge the battery of the game controller and run the systems of the game controller, as well as to pass-through charge the mobile computing device that is mounted on the game controller.

A system on chip (SOC) in the game controller can balance the power delivery between the game controller's battery, the game controller's system, and the wireless charger. This can be based on what power delivery capabilities the external charger has available (e.g., 2.5 W, 5 W, 10 W, 15 W, 20 W, etc). If the external charger, for example, can only deliver 15 W, the wireless charger can deliver 15 W, the battery can be charged at 5 W, and the rest of the system requires 2 W, then there is not enough power to maximize all systems (requiring 22 W versus the 15 W supply). To address this problem, the game controller can draw the maximum power and deliver the energy to the individual systems in a controlled and/or balanced manner.

The balance of power can be based on many factors, including but not limited to: (i) Battery state of mobile computing device's or game controller's internal battery. For example, the game controller's battery can be prioritized if the battery is low or if the internal power of the game controller's battery is almost fully charged. The rate of change over time of the battery state can also be analyzed to determine what needs to be charged; (ii) Thermal state of the game controller. The game controller can be getting warm from activity, charging, and the environment, and it may be desired to limit the effect of wireless charging on the game controller. This may prevent CPU/GPU/charge throttling or improve user experience; and (iii) Thermal state of internal electronics, wireless charger, or the battery. It may be desired to limit the temperature increase of sensitive systems or the user interface touch points.

In general, it may be desired to keep the charge rate of the game controller positive for a good user experience. If one system is being throttled in power usage, that power can be rerouted to other systems, or not used, as necessary. It is possible to create a charging state machine based on the above factors. However, in one embodiment, an application running on the mobile computing device can be used to inform decisions. Also, in one embodiment, neural networks and the information gathered by the application running on the mobile computing device can be used. If the application discovers that the user tends to run out of power on their device several times a day, the system may prioritize charging his device, as an extreme example. Alternatively, if the controller is very seldomly plugged in, the battery can be prioritized instead.

Additionally, the history of the device can be used to prioritize charging. If the user is currently playing a non-power-intensive game, the charge rate of the device can be lower, while if the game is power intensive (as evidenced by the change in power over the last 10 minutes, for example), the device can be prioritized. User input on the application can also be used to allow the user to select which system has priority.

In another embodiment, wireless charging is used not just as a pass-through but also to charge the host device from the game controller's battery or to charge the game controller's battery from the host device's battery. For example, if the host device is running low on power, the game controller can balance the charge state of both the host device and the game controller, within defined limits. For power savings and efficiency, adjustment of communications and polling interval can be made based on perceived inactivity. The communications interval is the configurable rate at which the wireless link is maintained (BT Classic, BLE, WiFi) and potentially at which the controller sends data over that link. Associated with that but independent from it is the polling interval—which is the time between reads of the input hardware (buttons, joysticks, etc.). These can be linked, but do not have to be, and—as we describe here—dynamically changing these rates can provide lower power usage when we detect periods of inactivity (in which various interrupt sources can wake us out of this lower power mode and increase the rates again).

Power states of the game controller can include states of faster or slower button polling rates and shorter and longer wireless communication intervals. To save energy, the game controller can adjust both intervals dynamically. The game controller can change to a more energy-efficient state when the user is not using the game controller. The list of states goes beyond on/off to a larger set of state combinations, depending on how certain the game controller is that the user is idle.

In some embodiments, artificial intelligence (AI)-based profiling of game players is used to determine when the game controller should go to sleep. The game controller can have several different power states as part of trying to be as power efficient as possible. These include active on (full power), off (minimum power), and several idle states where either communication or polling rate of the user interface can be reduced to save power. Other states and methods can be used to reduce the power consumption of the game controller.

Typically, a predefined state table can be used to switch between states based on stimuli. These may include: (i) Button Presses—For example, if the user has not pressed any buttons in X minutes (timeout), the controller can go idle or even turn off. Alternatively, if the user presses a button, the game controller can become more active; (ii) Bluetooth Connection State—If the connection attempt timed out, the game controller can go idle or turn off; (iii) Accelerometer or IMU Data on the Game Controller or Mobile Computing Device—This information can be used to determine whether a user has put the game controller and/or mobile computing device down, or picked them up. Some patterns, such as walking, can be recognized. If the IMU/accelerometer data from the mobile computing device and the game controller are very different, it may be determined that the user has removed their mobile computing device from the game controller; and (iv) Wireless Data (e.g., Bluetooth or NFC)—NFC requires proximity, so this data can be used to determine if a user removed or attached their mobile computing device to a game controller.

A table can be used as a base-state, but neural networks or basic data from the application running on the user's mobile computing device can be used to better inform the decisions. The application, type of application, or other behavior the user is engaged in can be used to determine what the system state of the game controller should be.

In one embodiment, there are four basic modes of operation as related to charging: (1) both battery changing and Qi pass-through charging active, (2) only Qi pass-through charging is active, (3) only battery charging is active (either phone is not accepting power or no phone attached), and (4) neither is being charged.

The following may be desired regarding the delivery of power from USB to the system, the battery, and the Qi 2.0 module, in order from highest priority to lowest priority: (1) system power, (2) internal battery (if less than low battery threshold), (3) phone battery (if Qi temperature lower than threshold), (4) internal battery (if higher than low battery threshold), and (5) phone battery (if Qi temperature higher than threshold). Some additional factors that can be taken into account can include, but are not limited to: (1) the temperature or change in temperature of the battery, (2) the temperature or change in temperature of the handles (if measurable), (2) the temperature or change in temperature of Qi, (4) the temperature or change in temperature of the phone (if measurable), (5) the available current from the USB-PD upstream, (6) the current state of charge of each battery, (7) information on gameplay and Δcharge of the phone, and (8) data on user habits.

In some situations, the limiting reagent on gameplay is power of the mobile computing device, not the power of the game controller, and users may need to charge their mobile computing device for extended gameplay. In some embodiments, parallel charging (i.e., charging both the game controller and mobile computing device) is used, and some of the pass-through charging power is diverted to top up the battery in the game controller. If the average game session length is known, the parallel charging can create the feeling that the game controller is battery-less (e.g., based on average session length, etc.).

### VI. Example Use Cases

The following are example use cases. It is important to note that these are merely examples and that the details provided herein should not be read into the claims.

### A. Universality

In some embodiments, when the game controller is attached to a host device (e.g., mobile computing device), such as an iPhone or Android operating system device, the game controller is recognized readily by the mobile phone's operating system.

In some embodiments, if the user wants to pair the game controller to a non-iPhone Bluetooth compatible device, then there is a way of connecting the game controller wirelessly to the device. For instance, an additional Bluetooth connect button may be designed into the game controller, enabling Bluetooth connectivity with non-iPhone devices, such as TVs or Macs. In some embodiments, an indication is provided to the user on an application running on the mobile computing device, on the game controller, or both when the Bluetooth connection is established and ready. For example, this can be in the form of a controller icon with a status ring. Additionally, in some embodiments, the game controller and app displays an indication to the user when the game controller has not successfully paired to the host device.

In some embodiments, if the user wants to physically connect the game controller to another device, such as an iPad to play a game, they can connect the game to the device via a USB type connection. The detection of the host type and selection of a human interface device (HID) report can be done automatically, as described, for example, in U.S. patent application Ser. No. 18/136,509, filed Apr. 19, 2023, and U.S. patent application Ser. No. 18/237,680, filed Aug. 24, 2023, both of which are hereby incorporated by reference.

In some embodiments, the system lets the user know if the game controller is not compatible in some way with the host device. For instance, if the phone or case does not support higher power charging, the user will be notified. In some embodiments, the game controller can detect Qi and pass-through power limits. For instance, the game controller can detect the presence of a Qi receiver. Additionally, the game controller can measure and communicate the power level of the pass-through power. The app should be able to detect when wireless charging is disabled on a phone and notify the user through the app's user interface. The game controller may be able to detect if the case does not support MagSafe (or other magnetic connection technology), so it can warn the user. In an embodiment, the app can have a list of phones that are compatible with Qi charging. Ideally, the app should not have to be installed for this to work through the computing device operating system. If the phone does not support BLE HID or BT BR/EDR gamepad, the user can be notified via the app.

In some embodiments, the game controller is kept up to date. If a new firmware (FW) update is available through an application running on the mobile computing device, the user can manually update his game controller through different ways, such as, but not limited to, USB HID support for firmware updates or Bluetooth support for firmware. In some embodiments, if a new firmware update is available through the app, the app can automatically update the game controller without initiation from the user.

In some embodiments, the game controller enables features that a user can use on iOS. For instance, if information is transferred over the phone, the app or the game controller can leverage iOS notifications. In another instance, if the user loses the game controller, they can find it using the “Find My” feature. In yet another instance, push notifications are supported.

In some embodiments, the game controller enables features that a user can use on the computing device's operating system. For instance, holding down an input button could open up context menus to share gameplay video through apps installed on the computing device.

### B. Portability

Example story: Candice is always out and about, whether it's commuting for work, meeting up with friends, or traveling for fun. When at home, she plays games on her laptop. She would like to be able to play those same games during her downtime when she is out of the home, but weighing the prospects between touchscreen controls or lugging a game controller around is not appetizing. A game controller design can overcome issues with portability, such as discussed above. For instance, the game controller is perceived as easy to grab and go. The weight of the game controller is lightweight and does not impact ergonomics, gameplay, or portability. In some embodiments, the mobile phone and game controller do not exceed 398 grams.

In some embodiments, a dedicated battery on the game controller facilitates play around and away from the home. For instance, when the game controller battery is in use, it will preferably have enough power for multiple play sessions over the course of a day, week, or month depending on battery size and usage. Such as described herein, the game controller can contain and use an internal battery when there is no external power available. In one embodiment, the internal battery aims for a target of at least 40 hours of gaming. When the game controller is not in use, it will not draw a significant amount of power, so that the user can use it after an extended time. In an embodiment, idle behavior has low power consumption. In some embodiments, standby power can last at least six months (4,368 hours) when 80% charged.

In some embodiments, the game controller has multiple power states to reduce average power consumption: (1) deep sleep, (2) light sleep, (3) active sleep, (4) active, and (5) hard power down. The game controller can wake up from an idle state based on user activity. Sensors can be used to detect user activity (e.g., accelerometers, Qvar sensor, Hall effect sensors (to detect bridge expansion), etc.).

### C. Delay to Play

Example story: Over time, it became too much of an effort for Deborah to remove her phone case every time she wanted to play, so she stopped using the game controller. When she first bought the game controller, she just assumed she did not need to remove her phone case, so it was a mild surprise and a bit of a disappointment. After a while though, fumbling with her case just to play for five minutes at a time started becoming a nuisance. And while Deborah still enjoyed using the game controller, she had other games on her phone that could entertain her and did not require the game controller. The embodiments described herein allow for Deborah to attach her phone to the game controller without removal of the case.

In some embodiments, a user can switch between phone mode and gaming mode as quickly as possible. If the user attaches the phone to the game controller in landscape/horizontal mode, then attachment happens quickly, if not instantly. The game controller can attach and hold to the phone using a magnetic connector, such as MagSafe, as the primary holding factor. Additional grip of the phone may come from the spring in the handles. Some embodiments enable extremely low user friction to connect the phone via MagSafe (e.g., less than three seconds with or without a case). Some embodiments enable a game controller to detect when MagSafe attach/detach occurs and trigger MagSafe animation or app with custom animation (or use system animation).

In some embodiments, a user places the top of the phone to make contact with one of the handles first, such as the left handle. After the top of the phone makes contact with the left handle, in this example, the user expands the game controller to accommodate the height of his phone. Once the bridge is expanded to an appropriate length, the rest of the phone can be laid down onto the game controller, and the magnet connecting element captures the phone. Once the phone is laid down onto the game controller, the controller collapses and grips the phone.

In some embodiments, when the phone is attached to the game controller, the two devices pair almost immediately without additional user intervention. For instance, the phone pairs to the game controller seamlessly without additional input (pairing credentials) from the user. In some embodiments, the game controller powers up when the host device is attached via MagSafe. This may be detected with a sensor separate from MagSafe itself. In an embodiment, the game controller has the ability to auto-connect after paired once. In some embodiments, the game controller auto-connects to the phone it is attached to, not necessarily the last connection. The game controller can identify the phone through MagSafe/NFC, for example.

In some embodiments, if the phone has a case, the user does not need to remove it to attach the game controller. For instance, the game controller can be compatible with iPhone Max dimensions (one of the largest mobile devices presently) with a case on, so the game controller handles can extend to fit max iPhone horizontal dimension plus the case.

When the game controller and phone are paired, the app running on the mobile computing device and/or game are ready to use. In some embodiments, the pairing of the game controller to the phone triggers the launch of the app and/or game.

When the user is done playing the game, he can just remove the game controller to go back to phone mode. The state of the phone is back to where the user left it by closing the application or the game content the user was playing.

### D. Immersion

Example story—Charles has been using his game controller and sometimes loses track of time while playing. However, if he plays for too long, he notices that his hands and fingers start to hurt. Maybe it is because of the smaller profile or maybe it us because of the button and joystick placement, but he does not feel like the game controller is as comfortable as his console controller. In some embodiments, the game controller is designed for long play time and has an input layout that is easy to reach when holding the game controller in a standard posture.

Example story—Jake enjoys playing fast-paced, Twitch shooters and their competitive style on the game controller. A split second of indecision in these games can determine life or death, winner or loser. In moments of high intensity, he notices that he will accidentally press the wrong button next to it. This is especially the case for the trigger and the bumper where pulling the trigger is to shoot and pushing the bumper is a secondary action. It can be a bit hard to feel which control he is pressing in the heat of a match, so it is frustrating when a misfires occur.

The user wants a wireless experience with minimal latency to avoid poor performance while gaming. If the user presses an input, there should be minimal chance of pressing the wrong input. Ultra-low latency equal to or better than certain controllers. In some embodiments, BLE with isochronous channels at 2.5 ms update rate is possible. Update rate can be adjustable via commands.

The user wants to be able to better differentiate between the controls to avoid pressing the wrong one. If the user presses an input, there should be minimal chance of pressing the wrong input. The spacing between inputs provides a tactility to discern and differentiate them during gameplay.

Example story—Jamie plays games frequently on his phone. While he started with basic puzzler games, he has recently discovered more complex games, such as COD Mobile and Genshin Impact. Unfortunately, these types of games also heat up his phone and drain his phone battery much more than what he used to playing. He would play more often while he was away from home if he was not worried about his phone being hot all the time and dying when he needs to use it for non-gaming tasks.

The user wants to play games without worrying about his phone overheating. In some embodiments, the game controller bridge or MagSafe island can act as a heat sink pulling heat away from the mobile computing device as it heats up during gameplay. Some embodiments may incorporate further Passaic or active cooling into the magnetic connector island to improve thermal efficiency. In additional embodiments, a fan or static heat pipes can guide heat away from the phone. The user does not want to worry about the battery state of the phone while playing games. If the phone battery gets low, the user can be given ample warning that it needs to be charged. The user can be notified when the phone battery drops below 20%, for example,

In some embodiments, if the user wants to charge the game controller while playing, he can charge using it while using it. For instance, the game controller can have a pass-through charging port, such as a USB-C pass-through charging port, to charge the phone and game controller while gaming. A full charge through USB-C in less than two hours when using a PD Charger may be possible. Less than two hours to charge from battery reporting completely drained, to battery reporting completely full, assuming a USB-PD charger and no phone connected, is possible. Support of non-USB-PD chargers with up to 500 mA charging current is possible. If the game controller is attached to the phone, the user can check the game controller's remaining battery life. The phone can the game controller's state of charge when the game controller is attached. LEDs can display the state of the charge when the game controller is attached to a phone.

In some embodiments, when the phone battery requires charging, it charges quickly, efficiently, and by multiple ways. Support for pass-through charging at a rate comparable to MagSafe standard charger is possible. Battery and pass-through charging can be active simultaneously with the proportion set by firmware. This can allow for adjustments for thermal losses and based on existing battery and phone charge. Support for 22.5 W→15 W charging is possible.

The user does not want to worry about the battery state of the controller while playing games. As such, in some embodiments, if the controller battery gets low, then the user is given ample warning that the controller needs to be charged. The user is notified when the controller battery drops below 20%.

If the controller is not attached to the phone but is in standalone mode (e.g. Apple TV), the user can check the game controller for its remaining battery life. The game controller LEDs can display the game controller's state of charge when the battery is low. The user can manually activate the game controller's LEDs to indicate the game controller's state of charge at any time.

If the game controller is not attached to a phone and not in use, the user can check the game controller for its remaining battery life. The user can manually activate the game controller's LEDs to indicate the game controller's state of charge at any time.

### VII. Conclusion

Any embodiment, implementation, feature, and/or example described herein is not necessarily to be construed as preferred or advantageous over any other embodiment, implementation, feature, and/or example unless stated as such. Thus, other embodiments, implementations, features, and/or examples may be utilized, and other changes may be made without departing from the scope of the subject matter presented herein. Accordingly, the details described herein are not meant to be limiting. It will be readily understood that the aspects of the present disclosure, as generally described herein, and illustrated in the figures, can be arranged, substituted, combined, separated, and designed in a wide variety of different configurations.

Further, unless the context suggests otherwise, the features illustrated in each of the figures may be used in combination with one another. Thus, the figures should be generally viewed as component aspects of one or more overall embodiments, with the understanding that not all illustrated features are necessary for each embodiment. Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, terms such as “A coupled to B” or “A is mechanically coupled to B” do not require members A and B to be directly coupled to one another. It is understood that various intermediate members may be utilized to “couple” members A and B together.

Moreover, terms such as “substantially” or “about” that may be used herein, are meant that the recited characteristic, parameter, or value need not be achieved exactly but that deviations or variations, including, for example, tolerances, measurement error, measurement accuracy limitations and other factors known to skill in the art, may occur in amounts that do not preclude the effect the characteristic was intended to provide.

Also, when reference is made in this application to two or more defined steps or operations, such steps or operations can be carried out in any order or simultaneously, unless the context excludes those possibilities. Furthermore, the term “comprises” and its grammatical equivalents are used in this application to mean that other components, features, steps, processes, operations, etc. are optionally present. For example, an article “comprising” or “which comprises” components A, B, and C can contain only components A, B, and C, or it can contain components A, B, and C along with one or more other components. Additionally, directions such as “right” and “left” (or “top,” “bottom,” etc.) are used for convenience and in reference to the views provided in figures. But the game controller may have a number of orientations in actual use. Thus, a feature that is vertical, horizontal, to the right, or to the left in the figures may not have that same orientation or direction in actual use.

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the embodiments described herein can be used alone or in combination with one another.

What is claimed is:

1. A game controller comprising:
a first handle;
a second handle;
a bridge coupling the first and second handles; and
a magnetic connector configured to provide a magnetic connection with an external device, wherein the magnetic connector is coupled with the bridge and positioned between the first and second handles, and wherein the game controller is configured such that the magnetic connector is free to move relative to the first and second handles.

2. The game controller of claim 1, wherein the magnetic connector is free to move along one or both of (i) an axis between the first and second handles or (ii) an axis substantially perpendicular to the axis between the first and second handles.

3. The game controller of claim 1, further comprising a magnetic connector island for carrying the magnetic connector, wherein the magnetic connector island is coupled with the bridge and positioned between the first and second handles, and wherein the magnetic connector is coupled to the bridge via the magnetic connector island.

4. The game controller of claim 3, wherein the bridge and the magnetic connector island are fixed relative to the first and second handles, and wherein the game controller being configured such that the magnetic connector is free to move relative to the first and second handles comprises the game controller being configured such that the magnetic connector is free to move along a slot in the magnetic connector island.

5. The game controller of claim 3, wherein the bridge is fixed relative to the first and second handles, and wherein the game controller being configured such that the magnetic connector is free to move relative to the first and second handles comprises the game controller being configured such that the magnetic connector island is free to move relative to the bridge.

6. The game controller of claim 3, wherein the game controller being configured such that the magnetic connector is free to move relative to the first and second handles comprises the game controller being configured such that the bridge and the magnetic connector island are free to move relative to the first and second handles.

7. The game controller of claim 1, wherein:
the magnetic connector island is positioned between the first and second handles such that, when the bridge is in a retracted position, the magnetic connector is off-center between the first and second handles; and
the first and second handles are configured to move in a non-synchronized and non-equidistant manner away from the magnetic connector island such that the magnetic connector is centered between the first and second handles when the bridge is in an extended position.

8. The game controller of claim 7, wherein the first and second handles are configured to move in the non-synchronized and non-equidistant manner via a dual rack-and-pinion system with different gear ratios.

9. The game controller of claim 7, wherein:
the bridge is configured to move between the retracted position and the extended position in first and second stages;
in the first stage, only one of the first and second handles moves until the magnetic connector is centered; and
in the second stage, both the first and second handles move while the magnetic connector stays centered.

10. The game controller of claim 1, wherein the magnetic connector is configured to rotate upon movement of the first and second handles.

11. A game controller comprising:
a first handle;
a second handle;
a bridge coupling the first and second handles;
a magnetic connector configured to provide a magnetic connection with an external device; and
a magnetic connector island for carrying the magnetic connector that is coupled with the bridge and positioned between the first and second handles, wherein the game controller is configured such that the bridge and the magnetic connector island are free to move together relative to the first and second handles.

12. The game controller of claim 11, further comprising a pinion gear coupling the bridge and the first and second handles, wherein the game controller being configured such that the bridge and the magnetic connector island are free to move together relative to the first and second handles comprises the game controller being configured such that the bridge and magnetic connector island are free to move together relative to the first and second handles via a movable shaft of the pinion gear.

13. The game controller of claim 11, further comprising a movable gear belt coupling the bridge and the first and second handles, wherein the game controller being configured such that the bridge and the magnetic connector island are free to move together relative to the first and second handles comprises the game controller being configured such that the bridge and magnetic connector island are free to move together relative to the first and second handles via the movable gear belt.

14. The game controller of claim 11, wherein the bridge and the magnetic connector island are free to move together along an axis between the first and second handles.

15. The game controller of claim 14, wherein the game controller is further configured such that the magnetic connector island is free to move relative to the bridge along an axis that is substantially perpendicular to the axis between the first and second handles.

16. A game controller comprising:
a first handle;
a second handle;
a bridge coupling the first and second handles;
a magnetic connector configured to provide a magnetic connection with an external device; and
a magnetic connector island for carrying the magnetic connector that is coupled with the bridge and positioned between the first and second handles,
wherein the game controller is configured such that the magnetic connector island is free to move relative to the bridge.

17. The game controller of claim 16, wherein the game controller is configured such that a force required to move the magnetic connector island relative to the bridge is less than a shear force between the magnetic connector and a computing device that is magnetically coupled with the magnetic connector.

18. The game controller of claim 16, wherein one of the magnetic connector island or the bridge comprises a protrusion and the other of the magnetic connector island or the bridge comprises a slot and wherein the game controller being configured such that the magnetic connector island is free to move relative to the bridge comprises the game controller being configured such that the magnetic connector island is free to move relative to the bridge via movement of the protrusion in the slot.

19. The game controller of claim 18, wherein the slot is oriented in one or both of (i) an axis between the first and second handles or (ii) an axis that is substantially perpendicular to the axis between the first and second handles.

20. The game controller of claim 18, wherein the slot is square diamond shaped.

21. The game controller of claim 16, wherein the magnetic connector island has an internal tunnel, wherein the bridge is positioned within the internal tunnel of the magnetic connector island, and wherein the internal tunnel is sized to allow the magnetic connector island to move along an axis that is substantially parallel to an axis between the first and second handles.
